(19) United States
(12) Patent Application Publication
(10) Pub. No.: US 2025/0084251 A1
(43) Pub. Date: Mar. 13, 2025

(54) Pigment preparations

(71) Applicant: LANXESS Deutschland GmbH, Cologne (DE)

(72) Inventors: Frank Linke, Cologne (DE); Lars May, Langenfeld (DE); Sabine Endert, Pulheim (DE); Hans-Ulrich Borst, Elsdorf (DE)

(73) Assignee: LANXESS Deutschland GmbH, Cologne (DE)

(21) Appl. No.: 18/817,931

(22) Filed: Aug. 28, 2024

(30) Foreign Application Priority Data
Sep. 7, 2023 (EP) 23195907.3

(51) Int. Cl. C09B 67/20; C09B 56/00

(52) U.S. Cl. CPC C09B 67/0065; C09B 56/00

(57) ABSTRACT

The present invention relates to new pigment preparations based on metal azo pigments and aliphatic C₁₀₋₂₂ monocarboxylic acids, to processes for their production and their use as a yellow pigment for colouring plastics, and to the use of aliphatic C₁₀₋₂₂ monocarboxylic acids for improving the filtration properties of pigment preparations with at the same time improved colour strengths.

The present invention relates to new pigment preparations based on metal azo pigments and aliphatic C₁₀₋₂₂ monocarboxylic acids, to processes for their production and their use as yellow pigment for colouring plastics, and to the use of aliphatic C₁₀₋₂₂ monocarboxylic acids for improving the filtration properties of pigment preparations with simultaneously improved colour strengths.

### BACKGROUND OF THE INVENTION

Metal complexes of azobarbituric acid with nickel salts and their use as yellow pigments have been widely described in the literature, e.g. W. Herbst, K. Hunger, Industrial Organic Pigments, 3rd edition 2004, pp. 390-397. It is also known that these products can be further reacted, for example with melamine or melamine derivatives, in order to improve the performance properties of these pigments, especially in the colouring of plastics and paints and as colour filters for LCDs (liquid crystal displays). In the literature it is also described that in order to adapt colouristic properties, these metal azo complexes may contain at least one further salt of various metals in addition to nickel salts. EP-A 1 591 489 discloses metal complexes of azo compounds based on alkali metals, alkaline earth metals, lanthanoids, aluminium, scandium, titanium, vanadium, chromium, manganese, cobalt, copper, nickel and zinc. The pigments according to EP-A 1 591 489 have a different colour location compared to pure nickel-azobarbituric acid complexes. The colour location describes the position of a measured or selected colour in a colour space and is usually defined by coordinates, preferably with the coordinates L*, a* and b* in the CIELAB colour space. The amount of all the colour locations in a colour space is referred to as the gamut or colour gamut; see: https://de.wikipedia.org/wiki/Farbraum. Although EP-A 1 591 489 contains statements on binder colour strength, determined in accordance with the Bayer Farben Revue, Special Issue 3/2 D, Farbmessung [Colour measurement] 1986, there are no statements on filterability or on the determination of the filter pressure value FPV according to DIN EN ISO 23900-5:2019-01.

The literature also discloses treating the surface of pigments with adjuvants. For example, the dispersion properties of pigments are to be improved by such surface coverage. However, increasing coverage of the pigment surface is always associated as well with a loss of colour strength. Such surface treatment of azo pigments is known, for example, from “W. Herbst, K. Hunger, Industrial Organic Pigments (Production, Properties, Applications), 3rd Completely Revised Edition (2004), Wiley-VCH-Verlag, pp. 202-203.

From EP-A 3 072 932 and EP-A 3 222 680, pigments based on metal-azobarbituric acid and melamine are known which contain copper and nickel ions and optionally further metal ions. These pigments are notable for improved dispersion properties with simultaneous increase in colour strength. However, EP-A 3 072 932 and EP-A 3 222 680 do not contain any statements regarding the filterability or the determination of the filter pressure value FPV according to DIN EN ISO 23900-5:2019-01.

From EP-A 3 981 840, pigments based on metal-azobarbituric acid and melamine are known which contain copper and nickel ions and optionally further metal ions and have a surface coverage with specific fatty acid derivatives. These products feature improved heat stability and supposedly high colour strengths, without more precise information on the latter.

EP-A 1 612 246 discloses, among others, five nickel azobarbiturate-melamine pigments with improved dispersibility. EP-A 1 612 246 contains no statements on the relative colour strength, nor on the filterability or the determination of the filter pressure value FPV according to DIN EN ISO 23900-5:2019-01.

The metal azo pigments known from the prior art are insufficient in terms of their performance features and there is therefore a need for improved metal azo pigments, in particular with regard to their filtration properties with at least retention of the colour strength.

It has now been found surprisingly that pigment preparations based on at least two zinc- and nickel-based metal azo compounds in combination with at least one aliphatic C₁₀₋₂₂ monocarboxylic acid have improved filtration properties with simultaneously improved colour strengths when 100 to 250 g of the aliphatic C₁₀₋₂₂ monocarboxylic acid are used per mole of all metal azo compounds contained in the metal azo pigment.

### SUMMARY OF THE INVENTION

A subject of the present invention is pigment preparations composed of
i) a metal azo pigment A) containing
   a) at least two metal azo compounds of formula (I) which differ at least in the metal ion Me, or their tautomeric forms,

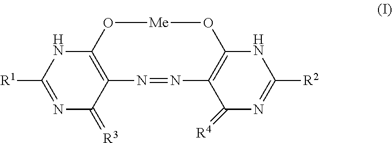

wherein
R¹ and R² are each independently OH, NH₂ or NHR⁵,
R³ and R⁴ are each independently O or NR⁵,
R⁵ is hydrogen or alkyl, preferably C₁-C₄ alkyl, and
Me is metal ions Me¹ in the first metal azo compound and a metal ion Me² in the second metal azo compound,
wherein
Me¹ is Zn²⁺ and Ni²⁺ and the molar ratio of Zn to Ni metal ions is 97:3 to 3:97, and
Me² is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺, Y³⁺_{2/3}, Sc³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺,
with the proviso that the amount of metal ions Me¹ is in total 97 to 100 mol % and the amount of metal ions selected from the Me² series is in total 0 to 3 mol %, based in each case on one mole of all compounds of formula (I), and
b) at least one compound of formula (II)

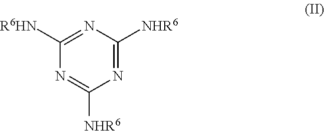

wherein
R⁶ is in each case independently hydrogen or alkyl, preferably C₁-C₄ alkyl, which is optionally substituted one or more times by OH,
or a reaction product of (I) with (II), preferably a reaction product of (I) with melamine,
and
(ii) 100 to 250 g of at least one aliphatic C₁₀₋₂₂ monocarboxylic acid B) per mole of all metal azo compounds (I) contained in the metal azo pigment A).

However, the invention also relates to the use of at least one aliphatic C₁₀₋₂₂ monocarboxylic acid B) for improving simultaneously the filter pressure value FPV to be determined with the pressure filter test according to DIN EN ISO 23900-5:2019-01 and the colour strength to be determined according to DIN 55986 of pigment preparations containing a metal azo pigment A), composed of
a) at least two metal azo compounds of formula (I) which differ at least in the metal ion Me, or their tautomeric forms,

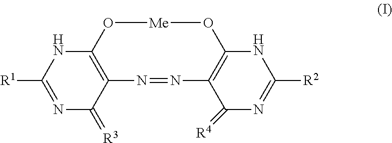

wherein
R¹ and R² are each independently OH, NH₂ or NHR⁵,
R³ and R⁴ are each independently O or NR⁵,
R⁵ is hydrogen or alkyl, preferably C₁-C₄ alkyl, and
Me is metal ions Me¹ in the first metal azo compound and a metal ion Me² in the second metal azo compound,
wherein
Me¹ is Zn²⁺ and Ni²⁺ and the molar ratio of Zn to Ni metal ions is 97:3 to 3:97, and
Me² is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺, Y³⁺_{2/3}, Sc³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺,
with the proviso that the amount of metal ions Me¹ is in total 97 to 100 mol % and the amount of metal ions selected from the Me² series is in total 0 to 3 mol %, based in each case on one mole of all compounds of formula (I), and
b) at least one compound of formula (II)

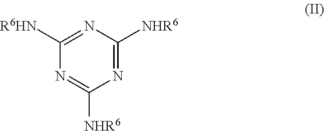

wherein
R⁶ is in each case independently hydrogen or alkyl, preferably C₁-C₄ alkyl, which is optionally substituted one or more times by OH,
or a reaction product of (I) with (II), preferably a reaction product of formula (I) with melamine,
   with the proviso that 100 to 250 g of the aliphatic C₁₀₋₂₂ monocarboxylic acid B) are used per mole of all metal azo compounds (I) contained in the metal azo pigment A).

The invention also relates to a process for simultaneously improving the filter pressure value FPV to be determined with the pressure filter test according to DIN EN ISO 23900-5:2019-01 and the colour strength to be determined according to DIN 55986 of pigment preparations containing a metal azo pigment A) composed of
a) at least two metal azo compounds of formula (I) which differ at least in the metal ion Me, or their tautomeric forms,

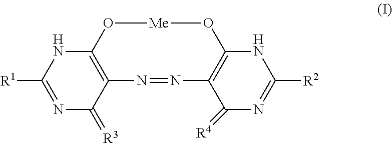

wherein
R¹ and R² are each independently OH, NH₂ or NHR⁵,
R³ and R⁴ are each independently O or NR⁵,
R⁵ is hydrogen or alkyl, preferably C₁-C₄ alkyl, and
Me in the first metal azo compound denotes Me¹ and is Zn²⁺ and Ni²⁺, where the molar ratio of Zn to Ni metal ions is 97:3 to 3:97,
and
   Me in the second metal azo compound denotes Me² and is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, HO³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ or Y³⁺_{2/3}. Sc³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺,
   with the proviso that the amount of metal ions Me¹ is in total 97 to 100 mol % and the amount of metal ions selected from the Me² series is in total 0 to 3 mol %, based in each case on one mole of all compounds of formula (I), and
b) at least one compound of formula (II)

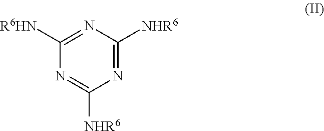

wherein
R⁶ is in each case independently hydrogen or alkyl, preferably C₁-C₄ alkyl, which is optionally substituted one or more times by OH,
or a reaction product of (I) with (II), preferably a reaction product of formula (I) with melamine,
by using 100 to 250 g of at least one aliphatic C₁₀₋₂₂ monocarboxylic acid B) per mole of all metal azo compounds (I) contained in the metal azo pigment A).

If, in formula (I), Me is a 3-valent metal ion, the charge is equalized in all cases by an equivalent amount of anionic structural units of formula (Ia)

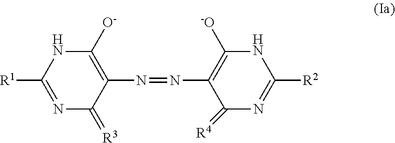

wherein R¹, R², R³ and R⁴ have the meanings indicated for formula (I).

For the sake of clarity, it should be noted that the scope of the present invention encompasses all the definitions and parameters cited in general or in preferred ranges, in any desired combinations. This also applies to quantities to be used in the processes and uses claimed under the present application. The standards cited in the context of this application relate to the edition current at the filing date of the present invention. Unless otherwise stated reported percentages are percentages by weight. Substituents in the meaning of alkyl refer to straight-chain or branched hydrocarbon radicals, preferably C₁-C₆ alkyl, particularly preferably C₁-C₄ alkyl, which may be optionally substituted one or more times by identical or different substituents, in particular by chlorine, bromine, fluorine; —OH, —CN, —NH₂ or C₁-C₆ alkoxy.

Colour strength is a colorimetric quantity that describes the colouring ability of a colourant. A distinction is made between absolute and relative colour strength. The colour strength is the most important property of pigments; see: https://de.wikipedia.org/wiki/Farbstärke.

In the context of the present invention, the relative colour strength is determined according to DIN 55986. In the production of pigments, it is common to use not the absolute but the relative colour strength, measured against a standard. For this purpose, each batch to be tested is dispersed and used for colouring under the same conditions as the standard. The quotient (sample/standard) of the K/S values (Kubelka-Munk), which represent a measure of the light absorption of the overall system, is referred to as the relative colour strength and expressed as a percentage:

$${FS}_{rel} = \frac{{( K / S )}_{Probe}}{{( K / S )}_{Standard}} \cdot 100 \%$$

A value of 100% means that the sample has a colour strength identical to that of the standard; larger values mean a higher colour strength, meaning less pigment is required to convey a given hue.

The filter pressure value FPV is determined within the scope of the present invention by means of the pressure filter test according to DIN EN ISO 23900-5:2019-01 (determination of the pressure increase/protocol 2). This standard specifies a method for determining the degree of dispersion of a colourant in a thermoplastic. The process is suitable for testing colourants in the form of colour concentrates in all plastics used for extrusion and melt-spinning processes. The filter pressure value determined by this method is valid only for the equipment used, conditions and the plastic to be tested. The use of test conditions other than those specified may result in different outcomes. The production of the colour concentrate is not described in this part of ISO 23900. Therefore, the test results of the individual colourants are comparable only when the same method has been used to produce the colour concentrate. In accordance with DIN EN ISO 23900-5:2019-01, the respective pigment preparations to be examined are intensively mixed into polyamide 6 in the form of Durethan® B30S from LANXESS Deutschland GmbH, Cologne, with an addition of 1% titanium dioxide on a tumble mixer. The mixture obtained in this way is then extruded on a Leistritz ZSE 18HP twin-screw extruder at 225° C. and a speed of 700 rpm and the granulated material thus produced is filtered via a 25 μm filter at a temperature of 238° C., measuring the pressure increase occurring. The pressure difference between the initial pressure and the maximum pressure is used to calculate the filter pressure value FPV. The lower this pressure increase to be measured in bar/g, the better the filtration properties of the pigment preparation to be examined in the context of the present invention.

### PREFERRED EMBODIMENTS OF THE INVENTION

Preferably, the components a) contained in the metal azo pigments to be used in the invention, together with the components b), form so-called adducts, where adducts according to the invention mean “composite molecules”. The bonding between the molecules of such adducts takes place preferably by intermolecular interactions, by Lewis acid-base interactions or by coordinate bonds. According to the invention, the term “adduct” generally embraces all types of intercalation compounds or addition compounds.

The terms “intercalation compound” or “addition compound” within the meaning of the present invention are in particular to be understood to refer to compounds that are formed by virtue of intermolecular interactions such as van der Waals interactions or Lewis acid-base interactions. How intercalation proceeds is dependent both on the chemical properties of the component to be intercalated and also on the chemical nature of the host lattice. Such compounds are often also referred to as intercalation compounds. In the chemical sense, this refers to the incorporation of molecules, ions-occasionally even atoms-into chemical compounds.

Furthermore, the term “adduct” also embraces inclusion compounds, so-called clathrates. These represent compounds of two substances, one guest molecule of which is incorporated into a lattice or cage composed of a host molecule.

The terms “intercalation compound” or “addition compound” within the meaning of the present invention also include mixed intercalation crystals or interstitial compounds. These are chemical, non-stoichiometric, crystalline compounds of at least two elements.

In addition, the terms “intercalation compound” or “addition compound” in the context of the present invention shall also be understood to mean compounds which are formed on the basis of coordinate bonds or complex bonds. Such compounds are particularly referred to as mixed substitution crystals or mixed replacement crystals, in which at least two substances form a common crystal and the atoms of the second component sit at regular lattice sites of the first component.

Compounds which are suitable for forming an adduct as defined above with the metal azo compounds of formula (I) may be both organic and inorganic compounds. These compounds are referred to hereinafter as adduct formers.

Adduct formers suitable in principle come from the most diverse classes of compound. For purely practical reasons preference is given to such compounds which are liquid or solid under standard conditions (25° C., 1 bar). Among the liquid substances, preference is generally given to those having a boiling point of 100° C. or more, preferably of greater than or equal to 150° C. at 1 bar. Suitable adduct formers are generally acyclic and cyclic organic compounds, preferably aliphatic or aromatic hydrocarbons, which may be substituted, in particular by OH, COOH, NH₂, substituted NH₂, CONH₂, substituted CONH₂, SO₂NH₂, substituted SO₂NH₂, SO₃H, halogen, NO₂, CN, —SO₂-alkyl, —SO₂-aryl, —O-alkyl, —O-aryl, —O-acyl.

Carboxamides and sulfonamides are one preferred group of adduct formers. Particularly suitable are also urea and substituted ureas such as phenylurea, dodecylurea and others and also their polycondensates with aldehydes, in particular formaldehyde, but also heterocycles, preferably barbituric acid, benzimidazolone, benzimidazolone-5-sulfonic acid, 2,3-dihydroxyquinoxaline, 2,3-dihydroxyquinoxaline-6-sulfonic acid, carbazole, carbazole-3,6-disulfonic acid, 2-hydroxyquinoline, 2,4-dihydroxyquinoline, caprolactam, melamine, 6-phenyl-1,3,5-triazine-2,4-diamine, 6-methyl-1,3,5-triazine-2,4-diamine, cyanuric acid.

Polymers, preferably water-soluble polymers, in particular ethylene-propylene oxide block polymers, preferably having an Mₙ greater than or equal to 1000, in particular from 1000 to 10 000 g/mol, polyvinyl alcohol, poly(meth)acrylic acids, modified cellulose, preferably carboxymethylcelluloses, hydroxyethylcelluloses and hydroxypropylcelluloses, methylhydroxyethylcelluloses and ethylhydroxyethylcelluloses, are likewise suitable in principle as adduct formers.

According to the invention, the adduct formers used are those of the formula (II). According to the invention, melamine is particularly preferred.

### PREFERRED EMBODIMENTS OF THE INVENTION

A preferred subject of the present invention is pigment preparations composed of
i) a metal azo pigment A) containing
   a) at least two metal azo compounds of formula (I) which differ at least in the metal ion Me, or their tautomeric forms,

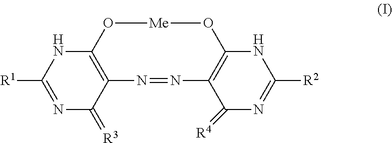

wherein
R¹ and R² are each independently OH, NH₂ or NHR⁵,
R³ and R⁴ are each independently O or NR⁵,
R⁵ is hydrogen or alkyl, preferably C₁-C₄ alkyl, and
Me is metal ions Me¹ in the first metal azo compound and a metal ion Me² in the second metal azo compound,
wherein
Me¹ is Zn²⁺ and Ni²⁺ and the molar ratio of Zn to Ni metal ions is 97:3 to 3:97, and
Me² is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺, Y³⁺_{2/3}, Sc³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺,
with the proviso that the amount of metal ions Me¹ is in total 97 to 100 mol % and the amount of metal ions selected from the Me² series is in total 0 to 3 mol %, based in each case on one mole of all compounds of formula (I), and
b) at least one compound of formula (II)

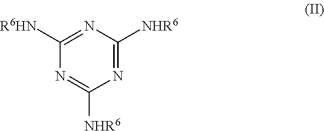

wherein
R⁶ is in each case independently hydrogen or alkyl, preferably C₁-C₄ alkyl, which is optionally substituted one or more times by OH,
and
(ii) 100 to 250 g of at least one aliphatic C₁₀₋₂₂ monocarboxylic acid B) per mole of all metal azo compounds (I) contained in the metal azo pigment A).

Preferably, in the metal azo pigments A), the ratio of metal azo compound (I) to the compound of formula (II) is 1 mol:0.05 to 4 mol, more preferably 1 mol:0.5 to 2.5 mol and especially preferably 1 mol:1.0 to 2.0 mol.

In one embodiment, the metal azo compounds A) contained in the pigment preparations according to the invention are the physical mixtures of the adducts of a) at least two metal azo compounds of formula (I) and b) at least one compound of formula (II). Preferably, they are the physical mixtures of the adducts of the pure Ni-azo compound with melamine and a pure Zn-azo compound with melamine.

Particularly preferably, though, the metal azo pigments A) contained in the pigment preparations according to the invention are the chemical mixed compounds of the adducts of a) at least two metal azo compounds of formula (I) and b) at least one compound of formula (II). These chemical mixed compounds are adducts of metal azo compounds in which the Ni and Zn atoms, and also optionally other metal ions Me², are incorporated into a common crystal lattice.

A preferred subject of the invention is pigment preparations composed of
i) a metal azo pigment A) containing
   a) at least two metal azo compounds of formula (I)

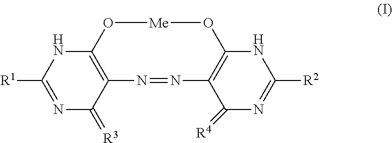

in which R¹ and R² are OH,
R³ and R⁴ are O,
Me in the first metal azo compound denotes Me¹ and is Zn²⁺ and Ni²⁺, where the molar ratio of Zn to Ni metal ions is 97:3 to 3:97, and Me in the second metal azo compound denotes Me² and Me² is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ oder Y³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺,
with the proviso that the amount of metal ions Me¹ in total is 97 to 100 mol % and the amount of metal ions Me² in total is 0 to 3 mol %, based in each case on one mole of all compounds of the formula (I), and
b) melamine (2,4,6-triamino-1,3,5-triazine, CAS No. 108-78-1), or alternatively a reaction product of formula (I) with melamine,
and
ii) 100 to 250 g of at least one aliphatic C₁₀₋₂₂ monocarboxylic acid B) per mole of all metal azo compounds (I) contained in the metal azo pigment A).

The invention relates particularly preferably to pigment preparations composed of
i) a metal azo pigment A) containing
   a) at least two metal azo compounds of formula (I)

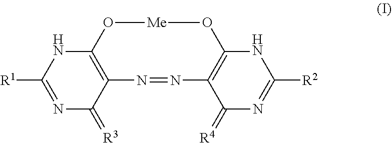

in which R¹ and R² are OH,
R³ and R⁴ are O,
Me in the first metal azo compound denotes Me¹ and is Zn²⁺ and Ni²⁺, where the molar ratio of Zn to Ni metal ions is 90:10 to 30:70, and
Me in the second metal azo compound denotes Me² and is Al³⁺_{2/3}, Fe²⁺, Fe³⁺_{2/3}, Co²⁺, Co³⁺_{2/3}, Ce³⁺_{2/3}, Mg²⁺, Ca²⁺, Sr²⁺, La³⁺_{2/3}, Mg²⁺, Mn²⁺, Nd²⁺, Nd³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺, Ca²⁺ or Ba²⁺,
with the proviso that the amount of metal ions Me¹ in total is 99 to 100 mol % and the amount of metal ions Me² in total is 0 to 1 mol %, based in each case on one mole of all compounds of the formula (I), and
b) melamine (2,4,6-triamino-1,3,5-triazine, CAS No. 108-78-1), or alternatively a reaction product of (I) and melamine,
and
i) 100 to 250 g of at least one aliphatic C₁₀₋₂₂ monocarboxylic acid B) per mole of all metal azo compounds (I) contained in the metal azo pigment A).

The invention relates especially preferably to pigment preparations composed of
i) a metal azo pigment A) containing
   a) at least two metal azo compounds of formula (I)

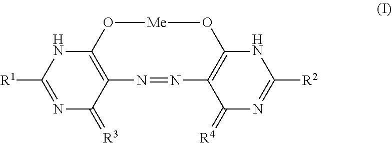

in which R¹ and R² are OH,
R³ and R⁴ are O,
Me in the first metal azo compound denotes Me¹ and is Zn²⁺ and Ni²⁺, where the molar ratio of Zn to Ni metal ions is 40:80 to 20:60, and
Me in the second metal azo compound denotes Me² and is Al³⁺_{2/3}, Fe²⁺, Fe³⁺_{2/3}, Ca²⁺, Co²⁺, Co³⁺_{2/3}, La³⁺_{2/3}, Mg²⁺, Nd²⁺ or Nd³⁺_{2/3},
with the proviso that the amount of metal ions Me¹ in total is 97 to 100 mol % and the amount of metal ions Me² in total is 0 to 3 mol %, based in each case on one mole of all compounds of the formula (I), and
b) melamine (2,4,6-triamino-1,3,5-triazine, CAS No. 108-78-1), or alternatively a reaction product of (I) and melamine,
and
ii) 100 to 250 g of at least one aliphatic C₁₀₋₂₂ monocarboxylic acid B) per mole of all metal azo compounds (I) contained in the metal azo pigment A).

Preferably, zinc and nickel are present in the at least two metal azo compounds of metal azo pigments of the invention in the ratio of 3 to 97 mol % Zn, 3 to 97 mol % Ni to 3 to 0 mol % Me².

Zinc and nickel are particularly preferably present in the at least two metal azo compounds of metal azo pigments of the invention in the ratio of 30 to 90 mol % Zn, 70 to 10 mol % Ni to 3 to 0 mol % Me².

Especially preferably, zinc and nickel are present in the at least two metal azo compounds of metal azo pigments of the invention in the ratio of 80 to 40 mol % Zn, 60 to 20 mol % Ni to 3 to 0 mol % Me².

With more particular preference, zinc and nickel are present in the at least two metal azo compounds of metal azo pigments of the invention in the ratio of 80 to 40 mol % Zn, 60 to 20 mol % Ni to 0 mol % Me².

The metal azo pigments A) contained in the pigment preparations according to the invention preferably have a specific surface area B.E.T., to be determined according to DIN 66131 (Determination of the specific surface area of solids by gas adsorption according to Brunauer, Emmett and Teller (B.E.T.)), of 50 to 200 m²/g, particularly preferably from 80 to 160 m²/g and especially preferably from 100 to 150 m²/g.

The metal azo pigments A) contained in the pigment preparations according to the invention are known in principle. Reference may be made in this regard to EP-A 3 072 932 or EP-A 3 222 680 and the production processes described therein.

Preferably, the metal azo pigments A) are obtainable by reaction of
a) at least two metal azo compounds of formula (I) which differ at least in the metal ion Me, or their tautomeric forms,

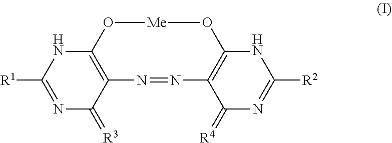

wherein
R¹ and R² are each independently OH, NH₂ or NHR⁵,
R³ and R⁴ are each independently O or NR⁵,
R⁵ is hydrogen or alkyl, preferably C₁-C₄ alkyl, and
Me is a metal ion Me¹ or Me²,
where Me¹ in the first metal azo compound (I) is Zn²⁺ and Ni²⁺ and the molar ratio of Zn to Ni metal ions is 97:3 to 3:97, and
Me² in the second metal azo compound (I) is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ or Y³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²,
with the proviso that the amount of metal ions Me¹ in total is 97 to 100 mol % and the amount of metal ions selected from the Me² series in total is 0 to 3 mol %, based in each case on one mole of all compounds of formula (I), with
b) at least one compound of formula (II)

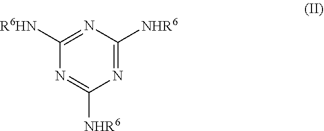

wherein
R⁶ is hydrogen or alkyl, preferably C₁-C₄ alkyl which is optionally substituted one or more times by OH.

The metal azo compounds (I) are obtainable by reaction of alkali metal salts of formula (III),

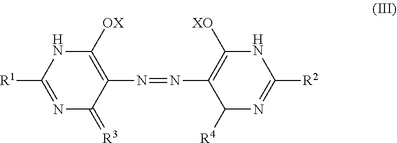

wherein
X is an alkali metal ion, preferably a sodium or potassium ion,
R¹ and R² are each independently OH, NH₂ or NHR⁵,
R³ and R⁴ are each independently O or NR⁵,
and
R⁵ is hydrogen or alkyl, preferably C₁-C₄ alkyl,
   or the tautomers thereof, preferably of the sodium or potassium salts,
   with nickel and zinc salts and optionally one or more Me² metal salts from the series of Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ or Y³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺ salts,
   wherein 0.001 to 0.999 mol of at least one nickel salt, 0.001 to 0.999 mol of at least one zinc salt and 0.03 to 0 mol of at least one metal salt from the series of the stated Me² metal salts are used per mole of compound of formula (III).

For the synthesis of metal azo compounds (I), 0.03 to 0.97 mol of at least one nickel salt and 0.97 to 0.03 mol of at least one zinc salt and 0.03 to 0 mol of at least one metal salt from the stated Me² metal salts series of salts are preferably used per mole of the compound of formula (III) in the context of the present invention.

For the synthesis of metal azo compounds (I), 0.1 to 0.7 mol of at least one nickel salt and 0.9 to 0.3 mol of at least one zinc salt and 0.03 to 0 mol of at least one metal salt from the series of the stated Me² metal salts are particularly preferably used per mole of the compound of formula (III) in the context of the present invention.

For the synthesis of metal azo compounds (I), 0.2 to 0.6 mol of at least one nickel salt and 0.8 to 0.4 mol of at least one zinc salt and 0.03 to 0 mol of at least one metal salt from the series of the salts of the stated Me² metal salts are especially preferably used per mole of the compound of formula (III) in the context of the present invention.

For the synthesis of metal azo compounds (I), 0.2 to 0.6 mol of at least one nickel salt and 0.4 to 0.4 mol of at least one zinc salt are more particularly preferably used per mole of the compound of formula (III) in the context of the present invention.

Preferably, the ratio of the components in the metal azo pigment A) is 1 mol of compound of formula (I): 0.05 to 4 mol of compound of formula (II), more preferably 1 mol of compound of formula (I): 0.5 to 2.5 mol of compound of formula (II), and especially preferably 1 mol of compound of formula (I): 1.0 to 2.0 mol of compound of formula (II).

The process for producing the metal azo pigments A) is preferably carried out at a temperature of 60 to 95° C. in aqueous solution at a pH below 7. The nickel and zinc salts to be used and the further Me² metal salts optionally to be used can be used individually or as a mixture with each other, preferably in the form of an aqueous solution. The compounds of the formula (II) can likewise be added individually or as a mixture with one another, preferably in the form of solids.

Preferably, the process for producing the metal azo pigments A) is carried out such that the azo compound of formula (III), preferably as the Na or K salt, is initially introduced, that one or more of the compound or compounds of formula (II) to be intercalated or added, in particular melamine, is or are added and then, simultaneously or successively, reaction takes place with at least one nickel salt and at least one zinc salt and optionally one or more Me² metal salts, preferably in the form of the aqueous solutions of these salts, preferably at pH values less than 7. Suitable substances for adjusting the pH are sodium hydroxide solution, potassium hydroxide solution, sodium carbonate, sodium hydrogencarbonate, potassium carbonate and potassium hydrogencarbonate.

Nickel and zinc salts suitable are preferably their water-soluble salts, in particular chlorides, bromides, acetates, formates, nitrates, sulfates, etc. Nickel and zinc salts for preferable use have a water solubility of more than 20 g/l, in particular more than 50 g/l at 20° C.

Me² metal salts suitable are preferably water-soluble Me² salts, especially preferably Me² chlorides, Me² bromides, Me² acetates, Me² nitrates and Me² sulfates, more particularly Me² chlorides.

The metal azo pigments A) obtained in this way can then be isolated by filtration of the aqueous suspension thereof as an aqueous filtercake. This filtercake can in turn be dried preferably after washing with hot water, by usual drying processes. Drying processes suitable are in particular the paddle drying or the spray drying of corresponding aqueous slurries. Finally, the pigment can be ground again.

The metal azo pigments A) contained in the pigment preparations according to the invention may also be produced by mixing the adducts of metal azo compounds of formula (I) in which Me stands for Ni²⁺ with adducts of metal azo compounds of formula (I) in which Me stands for Zn²⁺, and optionally with one or more adducts of metal azo compounds of formula (I) in which Me stands for a metal ion Me².

The aliphatic C₁₀₋₂₂ monocarboxylic acids B) contained in the pigment preparations according to the invention may be saturated or monounsaturated or polyunsaturated. Preferably, the aliphatic C₁₀₋₂₂ monocarboxylic acids B) are saturated or mono- to triunsaturated carboxylic acids. Particularly preferably, the aliphatic C₁₀₋₂₂ monocarboxylic acids B) contained in the pigment preparations according to the invention are saturated or mono- or diunsaturated carboxylic acids.

Especially preferably, at least one aliphatic C₁₀₋₂₂ monocarboxylic acid B) from the series of n-decanoic acid (CAS No. 334-48-5, capric acid, C₁₀H₂₀O₂), undec-10-enoic acid (CAS No. 112-38-9, undecylenic acid, C₁₁H₂₀O₂), dodecanoic acid (CAS No. 143-07-7, lauric acid, C₁₂H₂₄O₂), tetradecanoic acid (CAS No. 544-63-8, myristic acid, C₁₄H₂₈O₂), hexadecanoic acid (CAS No. 57-10-3, palmitic acid, C₁₆H₃₂O₂), octadecanoic acid (CAS No. 57-11-4, stearic acid, C₁₈H₃₆O₂), (9Z)-octadec-9-enoic acid (CAS No. 112-80-1, oleic acid, C₁₈H₃₄O₂) and n-docosanic acid (CAS No. 112-85-6, behenic acid, C₂₂H₄₄O₂) is used.

More particularly preferably, the aliphatic monocarboxylic acids B) contained in the pigment preparations according to the invention are those which contain 14 to 18 carbon atoms and which are saturated or monounsaturated.

More particularly preferably, the aliphatic monocarboxylic acids B) contained in the pigment preparations according to the invention are tetradecanoic acid (myristic acid), hexadecanoic acid (palmitic acid), octadecanoic acid (stearic acid) and (9Z)-octadec-9-enoic acid (oleic acid).

The aliphatic C₁₀₋₂₂ monocarboxylic acids B) contained in the pigment preparations according to the invention may be present in pure form or as mixtures.

Preferably, the mixtures of aliphatic monocarboxylic acids B) contained in the pigment preparations according to the invention are mixtures containing at least one saturated or monounsaturated aliphatic monocarboxylic acid having 14 carbon atoms, at least one saturated or monounsaturated aliphatic monocarboxylic acid having 16 carbon atoms and at least one saturated or monounsaturated aliphatic monocarboxylic acid having 18 carbon atoms.

Preferably, the mixtures of aliphatic monocarboxylic acids B) to be used according to the invention contain 0.5 to 5% by weight, particularly preferably 1 to 3% by weight of at least one saturated or monounsaturated aliphatic monocarboxylic acid having 14 carbon atoms, 25 to 60% by weight, preferably 30 to 50% by weight of at least one saturated or monounsaturated aliphatic monocarboxylic acid having 16 carbon atoms and 40 to 75% by weight, preferably 45 to 65% by weight of at least one saturated or monounsaturated aliphatic monocarboxylic acid having 18 carbon atoms.

Particularly preferably, the mixtures of aliphatic monocarboxylic acids B) contained in the pigment preparations according to the invention are mixtures containing myristic acid, palmitic acid and stearic acid and, with particular preference, in the above-indicated preferred ranges of quantities.

Such mixtures are known as commercial products of the company Unichema under the trade name “Pristerene®”, where the different chemical and quantitative compositions of these mixtures are characterized by a four-digit numerical code. Pristerene® 4910, containing a mixture of 2% by weight of myristic acid, 30% by weight of palmitic acid and 64% by weight of stearic acid, Pristerene® 4911, containing a mixture of 2% by weight of myristic acid, 45% by weight of palmitic acid and 52% by weight of stearic acid, Pristerene® 4922, containing a mixture of 0.7% by weight of myristic acid, 30% by weight of palmitic acid and 66% by weight of stearic acid and Pristerene® 9429.

The pigment preparations according to the invention preferably contain 100 to 250 g of at least one aliphatic monocarboxylic acid B) based on 1 mol of all metal azo compounds (I) contained in the metal azo pigment A).

Particularly preferably, the pigment preparations according to the invention contain 100 to 180 g, especially preferably 120 to 160 g of at least one aliphatic monocarboxylic acid B), based in each case on 1 mol of all metal azo compounds (I) contained in the metal azo pigment A).

The pigment preparations of the invention can be produced by mixing at least one metal azo pigment A) with at least one aliphatic monocarboxylic acid B). The mixing can be carried out mechanically, for example and preferably by stirring by means of suitable stirring devices such as slow-running stirrers, in particular blade, bar or planetary stirrers or centrifugal mixers, or fast-running stirrers, in particular propeller, turbine, disc or impeller stirrers. It is also possible to carry out mixing hydraulically by permanently pumping the reactor contents around, in particular by means of a centrifugal pump.

The metal azo pigment A) is preferably mixed in the form of an aqueous suspension with the at least one aliphatic monocarboxylic acid B). For the production of such an aqueous suspension, at least one dried and optionally ground metal azo pigment A) is mixed with a sufficient amount of water to produce a complete suspension of the metal azo pigment.

However, the metal azo pigment A) can also preferably be used directly in the form of the aqueous reaction mixture, as it arises in the synthesis of the metal azo pigment A).

For the production of pigment preparation according to the invention, an aqueous pigment suspension containing at least one metal azo pigment A) is admixed with stirring with at least one aliphatic monocarboxylic acid B), preferably at a temperature in the range from 60 to 95° C., preferably within a period of 10 to 60 minutes, and the mixture prepared in this way is preferably stirred for 60 to 240 minutes. The pH of the mixture is then adjusted to a value in the range from 3 to 7 and the pigment preparation is isolated via a suction filter or filter press. A pigment preparation obtainable in this way can be dried by means of usual drying processes. Drying processes suitable are preferably the paddle drying or the spray drying of corresponding aqueous slurries. The pigment preparation may then be ground again.

The pigment preparations according to the invention may also contain one or more auxiliaries and/or adjuvants. Preferably, all auxiliaries and adjuvants customary for pigment preparations are suitable as auxiliaries or adjuvants. Particularly preferred is the use of at least one auxiliary or adjuvant from the series of surface-active agents, in particular dispersants, surfactants, wetting agents, emulsifiers, bases and acids.

Therefore, in a preferred embodiment, another subject of the invention is a process for producing pigment preparations according to the invention, wherein at least one metal azo pigment A) is mixed with at least one aliphatic C₁₀₋₂₂ monocarboxylic acid B) and optionally one or more auxiliaries and/or adjuvants.

Owing to the surprisingly good filterability, to be determined by means of pressure filter test according to DIN EN ISO 23900-5:2019-01 based on the filter pressure value FPV, with at the same time a high colour strength, to be determined according to DIN 55986, the pigment preparations according to the invention are ideally suited for all pigment applications. In particular, the pigment preparations according to the invention are suitable for the mass colouring of synthetic, semi-synthetic or natural macromolecular substances, in particular polyvinyl chloride, polystyrene, polyamide, polyethylene or polypropylene, and for the spin dyeing of natural, regenerated or synthetic fibres, such as cellulose, polyester, polycarbonate, polyacrylonitrile or polyamide fibres, and for the printing of textiles and paper.

The invention therefore also relates to the use of the pigment preparations improved in filterability and colour strength by means of aliphatic C₁₀₋₂₂ monocarboxylic acids B) for the mass colouring of synthetic, semi-synthetic or natural macromolecular substances, in particular polyvinyl chloride, polystyrene, polyamide, polyethylene or polypropylene, and for the spin dyeing of natural, regenerated or synthetic fibres, such as cellulose, polyester, polycarbonate, polyacrylonitrile or polyamide fibres, and for the printing of textiles and paper.

### Preferred Uses

The invention preferably relates to the use of at least one aliphatic C₁₀₋₂₂ monocarboxylic acid B) for improving simultaneously the filter pressure value FPV to be determined by the pressure filter test according to DIN EN ISO 23900-5:2019-01 and the colour strength to be determined according to DIN 55986 of pigment preparations containing a metal azo pigment A) composed of
a) at least two metal azo compounds of formula (I)

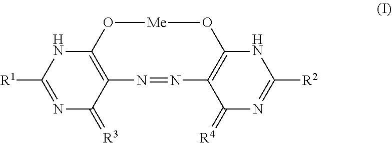

in which R¹ and R² are OH,
R³ and R⁴ are O,
Me¹ in the first metal azo compound (I) is Zn²⁺ and Ni²⁺ and the molar ratio of Zn to Ni metal ions is 97:3 to 3:97, and
Me² in the second metal azo compound (I) is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ or Y³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺ salts,
with the proviso that the amount of metal ions Me¹ in total is 97 to 100 mol % and the amount of metal ions Me² in total is 0 to 3 mol %, based in each case on one mole of all compounds of the formula (I), and
b) melamine (2,4,6-triamino-1,3,5-triazine, CAS No. 108-78-1), or which are obtainable by reaction of components a) and b).

The invention particularly preferably relates to the use of at least aliphatic C₁₀₋₂₂ monocarboxylic acid B) for improving simultaneously the filter pressure value FPV to be determined by the pressure filter test according to DIN EN ISO 23900-5:2019-01 and the colour strength to be determined according to DIN 55986 of pigment preparations containing a metal azo pigment A) composed of
a) at least two metal azo compounds of formula (I)

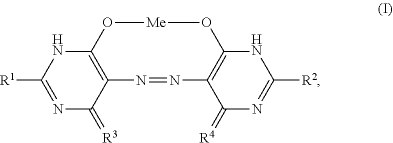

in which R¹ and R² are OH,
R³ and R⁴ are O,
Me¹ in the first metal azo compound is Zn²⁺ and Ni²⁺, where the molar ratio of Zn to Ni metal ions is 90:30 to 10:70, and
Me² in the second metal azo compound (I) is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ or Y³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺ salts,
with the proviso that the amount of metal ions Me¹ in total is 97 to 100 mol % and the amount of metal ions Me² in total is 0 to 3 mol %, based in each case on one mole of all compounds of the formula (I), and
b) melamine (2,4,6-triamino-1,3,5-triazine, CAS No. 108-78-1), or which are obtainable alternatively by reaction of components a) and b).

The invention especially preferably also relates to the use of at least one aliphatic C₁₀₋₂₂ monocarboxylic acid B) for improving simultaneously the filter pressure value FPV to be determined by the pressure filter test according to DIN EN ISO 23900-5:2019-01 and the colour strength to be determined according to DIN 55986 of pigment preparations containing a metal azo pigment A) composed of
a) at least two metal azo compounds of formula (I)

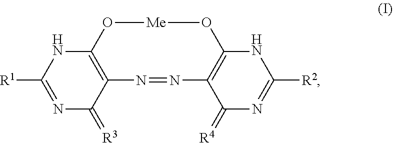

in which R¹ and R² are OH,
R³ and R⁴ are O,
Me¹ in the first metal azo compound is Zn²⁺ and Ni²⁺ and the molar ratio of Zn to Ni metal ions is 40:80 to 20:60, and
Me² in the second metal azo compound (I) is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ or Y³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺ salts,
with the proviso that the amount of metal ions Me¹ in total is 97 to 100 mol % and the amount of metal ions Me² in total is 0 to 3 mol %, based in each case on one mole of all compounds of the formula (I), and
b) melamine (2,4,6-triamino-1,3,5-triazine, CAS No. 108-78-1), or which are obtainable alternatively by reaction of components a) and b).

In the context of the uses, at least one aliphatic C₁₀₋₂₂ monocarboxylic acid B) from the series n-decanoic acid (CAS No. 334-48-5, capric acid, C₁₀H₂₀O₂), undec-10-enoic acid (CAS No. 112-38-9, undecylenic acid, C₁₁H₂₀O₂), dodecanoic acid (CAS No. 143-07-7, lauric acid, C₁₂H₂₄O₂), tetradecanoic acid (CAS No. 544-63-8, myristic acid, C₁₄H₂₈O₂), hexadecanoic acid (CAS No. 57-10-3, palmitic acid, C₁₆H₃₂O₂), octadecanoic acid (CAS No. 57-11-4, stearic acid, C₁₈H₃₆O₂), (9Z)-octadec-9-enoic acid (CAS No. 112-80-1, oleic acid, C₁₈H₃₄O₂) and n-docosanic acid (CAS No. 112-85-6, behenic acid, C₂₂H₄₄O₂) is especially preferably used.

More particularly preferably, the aliphatic monocarboxylic acids B) contained in the pigment preparations according to the invention are those which contain 14 to 18 carbon atoms and which are saturated or monounsaturated.

More particularly preferably, the aliphatic monocarboxylic acids B) contained in the pigment preparations according to the invention are tetradecanoic acid (myristic acid), hexadecanoic acid (palmitic acid), octadecanoic acid (stearic acid) and (9Z)-octadec-9-enoic acid (oleic acid).

In the context of the inventive uses, the aliphatic C₁₀₋₂₂ monocarboxylic acids B) may be present in pure form or as mixtures. Such mixtures are known as commercial products of the company Unichema under the trade name “Pristerene®”, where the different chemical and quantitative compositions of these mixtures are characterized by a four-digit numerical code. Preference according to the invention is given to Pristerene® 4910, containing a mixture of 2% by weight of myristic acid, 30% by weight of palmitic acid and 64% by weight of stearic acid, Pristerene® 4911, containing a mixture of 2% by weight of myristic acid, 45% by weight of palmitic acid and 52% by weight of stearic acid, Pristerene® 4922, containing a mixture of 0.7% by weight of myristic acid, 30% by weight of palmitic acid and 66% by weight of stearic acid and Pristerene® 9429.

### Preferred Processes

The invention preferably relates to a process for simultaneously improving the filter pressure value FPV to be determined by the pressure filter test according to DIN EN ISO 23900-5:2019-01 and the colour strength to be determined according to DIN 55986 of pigment preparations containing a metal azo pigment A) of
a) at least two metal azo compounds of formula (I)

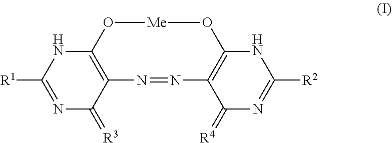

in which R¹ and R² are OH,
R³ and R⁴ are O,
Me¹ in the first metal azo compound (I) is Zn²⁺ and Ni²⁺ and the molar ratio of Zn to Ni metal ions is 97:3 to 3:97, and
Me² in the second metal azo compound (I) is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ or Y³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺ salts,
with the proviso that the amount of metal ions Me¹ in total is 97 to 100 mol % and the amount of metal ions Me² in total is 0 to 3 mol %, based in each case on one mole of all compounds of the formula (I), and
b) melamine (2,4,6-triamino-1,3,5-triazine, CAS No. 108-78-1), or which are obtainable alternatively by reaction of components a) and b),
   by using 100 to 250 g of at least one aliphatic C₁₀₋₂₂ monocarboxylic acid B) per mole of all metal azo compounds (I) contained in the metal azo pigment A).

The invention particularly preferably relates to a process for simultaneously improving the filter pressure value FPV to be determined by the pressure filter test according to DIN EN ISO 23900-5:2019-01 and the colour strength to be determined according to DIN 55986 of pigment preparations containing a metal azo pigment A) of
a) at least two metal azo compounds of formula (I)

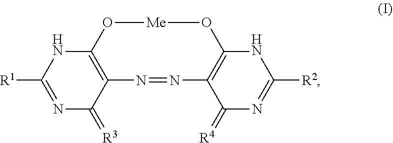

in which R¹ and R² are OH,
R³ and R⁴ are O,
Me¹ in the first metal azo compound is Zn²⁺ and Ni²⁺ and the molar ratio of Zn to Ni metal ions is 90:10 to 30:70, and
Me² in the second metal azo compound (I) is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ or Y³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺ salts,
with the proviso that the amount of metal ions Me¹ in total is 97 to 100 mol % and that the amount of metal ions Me² in total is 0 to 3 mol %, based in each case on one mole of all compounds of formula (I), and
b) melamine (2,4,6-triamino-1,3,5-triazine, CAS No. 108-78-1), or which are obtainable alternatively by reaction of components a) and b).
   by using 100 to 250 g of at least one aliphatic C₁₀₋₂₂ monocarboxylic acid B) per mole of all metal azo compounds (I) contained in the metal azo pigment A).

The invention especially preferably relates to a process for simultaneously improving the filter pressure value FPV to be determined by the pressure filter test according to DIN EN ISO 23900-5:2019-01 and the colour strength to be determined according to DIN 55986 of pigment preparations containing a metal azo pigment A) of
a) at least two metal azo compounds of formula (I)

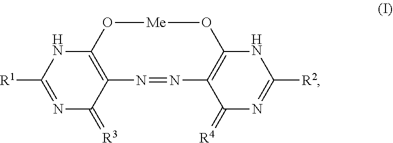

in which R¹ and R² are OH,
R³ and R⁴ are O,
Me¹ in the first metal azo compound is Zn²⁺ and Ni²⁺ and the molar ratio of Zn to Ni metal ions is 40:80 to 20:60, and
Me² in the second metal azo compound (I) is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺ or Y³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺ salts,
with the proviso that the amount of metal ions Me¹ in total is 99 to 100 mol % and the amount of metal ions Me² in total is 0 to 1 mol %, based in each case on one mole of all compounds of the formula (I), and
b) melamine (2,4,6-triamino-1,3,5-triazine, CAS No. 108-78-1), or which are obtainable alternatively by reaction of components a) and b),
   by using 100 to 250 g of at least one aliphatic C₁₀₋₂₂ monocarboxylic acid B) per mole of all metal azo compounds (I) contained in the metal azo pigment A).

In the context of the processes according to the invention, at least one aliphatic C₁₀₋₂₂ monocarboxylic acid B) from the series n-decanoic acid (CAS No. 334-48-5, capric acid, C₁₀H₂₀O₂), undec-10-enoic acid (CAS No. 112-38-9, undecylenic acid, C₁₁H₂₀O₂), dodecanoic acid (CAS No. 143-07-7, lauric acid, C₁₂H₂₄O₂), tetradecanoic acid (CAS No. 544-63-8, myristic acid, C₁₄H₂₈O₂), hexadecanoic acid (CAS No. 57-10-3, palmitic acid, C₁₆H₃₂O₂), octadecanoic acid (CAS No. 57-11-4, stearic acid, C₁₈H₃₆O₂), (9Z)-octadec-9-enoic acid (CAS No. 112-80-1, oleic acid, C₁₈H₃₄O₂) and n-docosanic acid (CAS No. 112-85-6, behenic acid, C₂₂H₄₄O₂) is especially preferably used.

More particularly preferably, the aliphatic monocarboxylic acids B) contained in the pigment preparations according to the invention are those which contain 14 to 18 carbon atoms and which are saturated or monounsaturated.

More particularly preferably, the aliphatic monocarboxylic acids B) contained in the pigment preparations according to the invention are tetradecanoic acid (myristic acid), hexadecanoic acid (palmitic acid), octadecanoic acid (stearic acid) and (9Z)-octadec-9-enoic acid (oleic acid).

In the context of the inventive processes, the aliphatic C₁₀₋₂₂ monocarboxylic acids B) to be used may be present in pure form or as mixtures. Such mixtures are known as commercial products of the company Unichema under the trade name “Pristerene®”, where the different chemical and quantitative compositions of these mixtures are characterized by a four-digit numerical code. Preference according to the invention is given to Pristerene® 4910, containing a mixture of 2% by weight of myristic acid, 30% by weight of palmitic acid and 64% by weight of stearic acid, Pristerene® 4911, containing a mixture of 2% by weight of myristic acid, 45% by weight of palmitic acid and 52% by weight of stearic acid, Pristerene® 4922, containing a mixture of 0.7% by weight of myristic acid, 30% by weight of palmitic acid and 66% by weight of stearic acid and Pristerene® 9429.

It will be understood that the specification and examples are illustrative but not limitative of the present invention and that other embodiments within the spirit and scope of the invention will suggest themselves to those skilled in the art.

### EXAMPLES

### I. Production of Metal-Azobarbituric Acid Melamine Pigments a to W According to the Prior Art

### Example 1: Nickel Azobarbituric Acid Melamine Pigment Preparation According to EP-A 26 82 435, Example 2 (Pigment A) (not According to the Invention)

### a) Production of the Crude Pigment

154.1 g (1.0 mol) of diazobarbituric acid and 128.1 g (1.0 mol) of barbituric acid were introduced into 3670 g of distilled water at 85° C. Subsequently, aqueous potassium hydroxide solution was used to establish a pH of 5 and the reaction mixture was stirred for 90 minutes. 5000 g of distilled water were added at 82° C. to the azobarbituric acid (1.0 mol) thus prepared. Subsequently, a pH of 2 to 2.5 was established by adding 33 g of 30% hydrochloric acid dropwise and 264.8 g (2.1 mol) of melamine were added. Subsequently, 1.0 mol of nickel chloride was added dropwise in the form of an around 25% solution. After 3 hours at 82° C. a pH of about 5.5 was established by adding potassium hydroxide.

### b) Aftertreatment

For this purpose, the product was diluted at 90° C. with around 330 g of distilled water. Then 70 g of 30% hydrochloric acid were added dropwise and the reaction mixture was stirred for 12 hours at 90° C. The pH of the reaction mixture was then adjusted to about 5 with aqueous potassium hydroxide solution.

### c) Workup

The pigment preparation obtainable from the aftertreatment b) was isolated on a suction filter, washed, dried at 80° C. in a vacuum drying oven and ground in a customary laboratory mill for around 2 minutes. (Pigment A)

### Examples 2 to 23: Metal-Azobarbituric Acid Melamine Pigments B to W

The pigments B to W of Examples 2 to 23 listed in Table 1 below were produced analogously to Example 1, but the 1.0 mol of nickel chloride was replaced respectively by mixtures of nickel chloride and zinc chloride and, optionally, a third metal chloride (Me²), in molar amounts as indicated in Table 1.

For the pigments A to W, the colour strength and the filter pressure values were determined as described in protocols 1 and 2 indicated below. The values can be found in Table 1.

TABLE 1
Pigments A to W

| | | | | | Colour | |
|---|---|---|---|---|---|---|
| | | Ni | Zn | Me² | strength | FPV |
| Example | Pigment | [mol %] | [mol %] | [mol %] | [%] | [bar/g] |
| 1 | A | 100 | 0 | 0 | 100 | 15.3 |
| 2 | B | 99.9 | 0.1 | 0 | 100 | 15.1 |
| 3 | C | 99.0 | 1.0 | 0 | 100 | 16.9 |
| 4 | D | 97 | 3 | 0 | 100 | 15.8 |
| 5 | E | 95 | 5 | 0 | 100 | 15.9 |
| 6 | F | 70 | 30 | 0 | 100 | 16.8 |
| 7 | G | 50 | 50 | 0 | 100 | 16.1 |
| 8 | H | 20 | 80 | 0 | 100 | 16.3 |
| 9 | I | 10 | 90 | 0 | 100 | 15.9 |
| 10 | J | 5 | 95 | 0 | 100 | 16.0 |
| 11 | K | 3 | 97 | 0 | 100 | 15.9 |
| 12 | L | 1 | 99 | 0 | 100 | 15.8 |
| 13 | M | 0.1 | 99.9 | 0 | 100 | 16.3 |
| 14 | N | 0 | 100 | 0 | 100 | 16.5 |
| 15 | O | 97 | 2 | 1 Ca | 100 | 15.9 |
| 16 | P | 17 | 80 | 3 Co | 100 | 15.6 |
| 17 | Q | 37 | 60 | 3 Al | 100 | 16.1 |
| 18 | R | 60 | 37 | 3 La | 100 | 16.3 |
| 19 | S | 45 | 52 | 3 Fe | 100 | 15.6 |
| 20 | T | 49 | 49 | 2 Ce | 100 | 16.1 |
| 21 | U | 20 | 79 | 1 Nd | 100 | 15.9 |
| 22 | V | 60 | 37 | 3 Mg | 100 | 15.1 |
| 23 | W | 50 | 49.5 | 0.5 Mg | 100 | 15.6 |

### Examples 24 to 28: Nickel Azobarbituric Acid Melamine Pigment Preparations According to EP-A 1 612 246 (not According to the Invention)

### Preliminary Stage 1

63 g of 35% hydrochloric acid were stirred into 150 g of water. 30 g of aminoguanidine bicarbonate were introduced into this mixture. After complete dissolution, the mixture was cooled to 0° C. After that, 19 g of sodium nitrite were added within 30 min and stirring was subsequently carried out at 0 to 15° C. for 30 min. Amidosulfonic acid was then added until no further colour reaction occurred with potassium iodide starch paper. Subsequently, 25.6 g of barbituric acid were added and the mixture was heated to 55° C. and subsequently stirred for 2 hours. Then 25.6 g of barbituric acid were added and the mixture was heated to 80° C. and adjusted with sodium hydroxide to pH 5. After 3 hours the temperature was lowered to 70° C. The resulting reaction product was then isolated and washed with hot water and the filtercake was dried at 80° C. Yield: 61.4 g of azobarbituric acid disodium salt.

### Preliminary Stage 2

63 g of 35% hydrochloric acid were stirred into 150 g of water. 38.7 g of benzenesulfonyl hydrazide were introduced into this mixture. The mixture was cooled to below 0° C. with ice. After that, 19 g of sodium nitrite were added within 30 min and stirring was subsequently carried out at 0 to 15° C. for 30 min. Amidosulfonic acid was then added until no further colour reaction occurred with potassium iodide starch paper. The pH was then adjusted to 7.0 to 9.0 with sodium hydroxide, 25.6 g of barbituric acid were added, and the mixture was heated to 50° C. and subsequently stirred for 2 hours. Then a further 25.6 g of barbituric acid were added, the mixture was heated to 80° C. and the pH of the mixture was adjusted to 5 with hydrochloric acid. After 3 hours, the temperature was lowered to 70° C., and the resulting reaction product was isolated and washed with hot water. The filtercake obtained was slurried in 1200 g of water and stirred for 2 hours at 80° C. After that, it was isolated and washed with 2000 g of water at 80° C. until benzenesulfonamide-free, and dried at 80° C. Yield: 61.0 g of azobarbituric acid disodium salt.

### Example 24

25 g of azobarbituric acid disodium salt from preliminary stage 1 and 0.5 g of oleic acid were introduced into 600 g of water, and stirred in homogeneously. Then the pH was adjusted to 1.0 and the mixture was heated to 95° C. 19.2 g of melamine were then added to the mixture and 18.6 g of nickel chloride hexahydrate, previously dissolved in 115 g of water, were added dropwise over the course of 5 min. After 1.5 hours at 90° C., the pH of the mixture was adjusted to 5.5 and stirring continued for 4 hours. The reaction product was then isolated and washed with hot water until free of salt and melamine. The filtercake was dried at 80° C. to a residual water content of less than 1.5%. Yield: 42 g of pigment.

### Example 25

25 g of azobarbituric acid disodium salt from preliminary stage 1 and 0.5 g of oleic acid were introduced into 600 g of water, and stirred in homogeneously. The pH was then adjusted to 8.5 and the mixture was heated to 95° C. 19.2 g of melamine were then added to the mixture. After subsequent stirring for 5 minutes, the pH of the mixture was adjusted to 5.0 with hydrochloric acid. After that, subsequent stirring took place for 5 minutes and then 18.6 g of nickel chloride hexahydrate, previously dissolved in 115 g of water, were added dropwise over the course of 10 min. After 1.5 hours at 90° C., the pH of the mixture was adjusted to 5.5 and stirring continued for 4 hours. The reaction product was then isolated and washed with hot water until free of salt and melamine. The filtercake was dried at 80° C. to a residual water content of less than 1.5%. Yield: 42 g of pigment.

### Example 26

25 g of azobarbituric acid disodium salt from preliminary stage 1 and 0.5 g of linoleic acid were introduced into 600 g of water, and stirred in homogeneously. Then the pH was adjusted to 8.5 and the mixture was heated to 95° C. 19.2 g of melamine were then added to the mixture. After subsequent stirring for 5 minutes, the pH of the mixture was adjusted to 5.0 with hydrochloric acid. This mixture was stirred for another 5 minutes and then 18.6 g of nickel chloride hexahydrate, previously dissolved in 115 g of water, were added dropwise over the course of 10 min. After 1.5 hours at 90° C., the pH of the mixture was adjusted to 5.5 and stirring continued for 4 hours. The reaction product was then isolated and washed with hot water until free of salt and melamine. The filtercake was dried at 80° C. to a residual water content of less than 1.5%. Yield: 41.8 g of pigment.

### Example 27

25 g of azobarbituric acid disodium salt from preliminary stage 1 and 0.5 g of α-linolenic acid (alpha-linolenic acid; CAS No. 463-40-1) were introduced into 600 g of water, and stirred in homogeneously. Then the pH was adjusted to 8.5 and the mixture was heated to 95° C. 19.2 g of melamine were then added to the mixture. After subsequent stirring for 5 minutes, the pH of the mixture was adjusted to 5.0 with hydrochloric acid, this mixture was stirred for another 5 minutes and then 18.6 g of nickel chloride hexahydrate, previously dissolved in 115 g of water, were added dropwise over the course of 10 minutes. After 1.5 hours at 90° C., the pH of the mixture was adjusted to 5.5 and stirring continued for 4 hours. The reaction product was then isolated and washed with hot water until free of salt and melamine. The filtercake was dried at 80° C. to a residual water content of less than 1.5%. Yield: 42 g of pigment.

### Example 28

25 g of azobarbituric acid disodium salt from preliminary stage 2 and 0.5 g of oleic acid (CAS No. 112-80-1) were introduced into 600 g of water, and stirred in homogeneously. Then the pH was adjusted to 1.0 and the mixture was heated to 95° C. 19.2 g of melamine were then added to the mixture and 18.6 g of nickel chloride hexahydrate, previously dissolved in 115 g water, were added dropwise over the course of 5 minutes. After 1.5 hours at 90° C., the pH of the mixture was adjusted to 5.5 and this mixture was stirred for another 4 hours. The reaction product was then isolated and washed with hot water until free of salt and melamine. The filtercake was dried at 80° C. to a residual water content of less than 1.5%. Yield: 41.4 g of pigment.

TABLE 2

| Example | Colour strength [%] | FPV [bar/g] |
|---|---|---|
| 24 | 98 | 16.9 |
| 25 | 95 | 16.2 |
| 26 | 95 | 15.9 |
| 27 | 98 | 16.3 |
| 28 | 93 | 16.5 |

### Colour Strength Compared to Example 1

### II. Production of the Pigment Preparations

### Example 29: Production of Pigment Preparation A-1 (not in Accordance with the Invention)

An aqueous suspension of pigment A, as obtained after step c) of Example 1, was admixed with 100 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation A-1)

### Examples 30 to 45: Production of Pigment Preparations A-2 to A-17 (not in Accordance with the Invention)

Analogously to Example 29, pigment preparations A-2 to A-17, not in accordance with the invention, were produced in Examples 30 to 45. In each case, an aqueous suspension of pigment A, as obtained after step c) of Example 1, was admixed with different aliphatic carboxylic acids B) or mixtures thereof in different amounts, as indicated in Table 2.

### Determination of Colour Strength and Filter Pressure Value

For pigment preparations A-1 to A-17, the colour strength compared to pigment A and the filter pressure value were determined according to protocols 1 and 2 indicated below. The values can also be found in Table 3.

TABLE 3
Pigment preparations with pigment A

| | | | Grams of aliphatic | | | |
|---|---|---|---|---|---|---|
| | | According | carboxylic acid | Aliphatic | Colour | |
| | Pigment | to the | B) or mixture per | carboxylic acid | strength | FPV |
| Example | preparation | invention | mole of pigment | B) or mixture | [%] | [bar/g] |
| 29 | A-1 | no | 100 | Pristerene ® 4910 | 94 | 15.9 |
| 30 | A-2 | no | 50 | Pristerene ® 4910 | 98 | 16.2 |
| 31 | A-3 | no | 270 | Pristerene ® 4910 | 90 | 15.9 |
| 32 | A-4 | no | 150 | Pristerene ® 4911 | 97 | 16.3 |
| 33 | A-5 | no | 150 | Pristerene ® 9429 | 95 | 16.5 |
| 34 | A-6 | no | 100 | Pristerene ® 4922 | 97 | 15.9 |
| 35 | A-7 | no | 150 | caprylic acid | 96 | 15.8 |
| 36 | A-8 | no | 100 | capric acid | 92 | 16.3 |
| 37 | A-9 | no | 150 | lauric acid | 95 | 16.2 |
| 38 | A-10 | no | 210 | myristic acid | 90 | 16.4 |
| 39 | A-11 | no | 270 | palmitic acid | 85 | 15.8 |
| 40 | A-12 | no | 250 | stearic acid | 89 | 15.7 |
| 41 | A-13 | no | 150 | behenic acid | 93 | 16.1 |
| 42 | A-14 | no | 150 | lignoceric acid | 92 | 16.5 |
| 43 | A-15 | no | 70 | oleic acid | 96 | 15.9 |
| 44 | A-16 | no | 150 | undecylenic acid | 91 | 15.9 |
| 45 | A-17 | no | 150 | nervonic acid | 90 | 16.3 |

### Example 46: Production of Pigment Preparation B-1 (not in Accordance with the Invention)

An aqueous suspension of pigment B, as obtained after step c) of Example 2, was admixed with 50 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation B-1)

### Examples 47 to 93: Production of Pigment Preparations B-2 to B-48 (not in Accordance with the Invention)

Analogously to Example 46, pigment preparations B-2 to B-48, not in accordance with the invention, were produced in Examples 47 to 93. In each case, an aqueous suspension of the pigment B, as obtained after step c) of Example 2, was admixed with different aliphatic carboxylic acids B) or mixtures thereof in different amounts, as indicated in Table 4.

### Determination of Colour Strength and Filter Pressure Value

For pigment preparations B-1 to B-48, the colour strength compared to pigment B and the filter pressure value were determined according to protocol 1 and 2 indicated below. The values can also be found in Table 4.

TABLE 4
Pigment preparations with pigment B

| | | | Grams of aliphatic | | | |
|---|---|---|---|---|---|---|
| | | According | carboxylic acid | Aliphatic | Colour | |
| | Pigment | to the | B) or mixture per | carboxylic acid | strength | FPV |
| Example | preparation | invention | mole of pigment | B) or mixture | [%] | [bar/g] |
| 46 | B-1 | no | 50 | Pristerene ® 4910 | 98 | 15.3 |
| 47 | B-2 | no | 180 | Pristerene ® 4910 | 95 | 15.6 |
| 48 | B-3 | no | 280 | Pristerene ® 4910 | 90 | 16.1 |
| 49 | B-4 | no | 50 | Pristerene ® 4911 | 97 | 16.3 |
| 50 | B-5 | no | 120 | Pristerene ® 4911 | 95 | 16.5 |
| 51 | B-6 | no | 280 | Pristerene ® 4911 | 89 | 16.1 |
| 52 | B-7 | no | 50 | Pristerene ® 9429 | 97 | 15.8 |
| 53 | B-8 | no | 70 | Pristerene ® 9429 | 96 | 15.8 |
| 54 | B-9 | no | 160 | Pristerene ® 9429 | 94 | 15.9 |
| 55 | B-10 | no | 210 | Pristerene ® 9429 | 91 | 16.1 |
| 56 | B-11 | no | 50 | Pristerene ® 4922 | 98 | 15.8 |
| 57 | B-12 | no | 100 | Pristerene ® 4922 | 95 | 15.9 |
| 58 | B-13 | no | 280 | Pristerene ® 4922 | 89 | 16.1 |
| 59 | B-14 | no | 50 | caprylic acid | 98 | 15.9 |
| 60 | B-15 | no | 280 | caprylic acid | 88 | 15.5 |
| 61 | B-16 | no | 70 | lignoceric acid | 97 | 16.2 |
| 62 | B-17 | no | 180 | lignoceric acid | 95 | 15.1 |
| 63 | B-18 | no | 70 | nervonic acid | 96 | 15.3 |
| 64 | B-19 | no | 210 | nervonic acid | 92 | 15.5 |
| 65 | B-20 | no | 50 | capric acid | 99 | 15.6 |
| 66 | B-21 | no | 210 | capric acid | 91 | 15.8 |
| 67 | B-22 | no | 280 | capric acid | 88 | 16.1 |
| 68 | B-23 | no | 50 | lauric acid | 98 | 16.1 |
| 69 | B-24 | no | 210 | lauric acid | 91 | 15.8 |
| 70 | B-25 | no | 280 | lauric acid | 88 | 15.6 |
| 71 | B-26 | no | 70 | myristic acid | 98 | 15.3 |
| 72 | B-27 | no | 160 | myristic acid | 95 | 15.6 |
| 73 | B-28 | no | 235 | myristic acid | 91 | 16.3 |
| 74 | B-29 | no | 70 | palmitic acid | 96 | 15.8 |
| 75 | B-30 | no | 180 | palmitic acid | 95 | 15.6 |
| 76 | B-31 | no | 250 | palmitic acid | 91 | 15.8 |
| 77 | B-32 | no | 280 | palmitic acid | 89 | 16.2 |
| 78 | B-33 | no | 50 | stearic acid | 99 | 15.8 |
| 79 | B-34 | no | 100 | stearic acid | 97 | 15.8 |
| 80 | B-35 | no | 210 | stearic acid | 95 | 16.2 |
| 81 | B-36 | no | 280 | stearic acid | 91 | 16.0 |
| 82 | B-37 | no | 50 | behenic acid | 98 | 15.8 |
| 83 | B-38 | no | 70 | behenic acid | 97 | 15.6 |
| 84 | B-39 | no | 210 | behenic acid | 95 | 16.3 |
| 85 | B-40 | no | 280 | behenic acid | 91 | 16.2 |
| 86 | B-41 | no | 70 | oleic acid | 98 | 15.8 |
| 87 | B-42 | no | 120 | oleic acid | 95 | 15.6 |
| 88 | B-43 | no | 250 | oleic acid | 92 | 15.8 |
| 89 | B-44 | no | 280 | oleic acid | 88 | 15.8 |
| 90 | B-45 | no | 70 | undecylenic acid | 98 | 16.5 |
| 91 | B-46 | no | 100 | undecylenic acid | 96 | 16.2 |
| 92 | B-47 | no | 210 | undecylenic acid | 91 | 16.5 |
| 93 | B-48 | no | 280 | undecylenic acid | 87 | 16.1 |

### Example 94: Production of Pigment Preparation C-1 (not in Accordance with the Invention)

An aqueous suspension of pigment C, as obtained after step c) of Example 3, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation C-1)

### Examples 95 to 136: Production of Pigment Preparations C-2 to C-44 (not in Accordance with the Invention)

Similarly to Example 94, pigment preparations C-2 to C-44 not in accordance with the invention were produced in Examples 95 to 137. In each case, an aqueous suspension of the pigment C, as obtained after step c) of Example 3, was admixed with different aliphatic carboxylic acids B) or mixtures thereof in different amounts, as indicated in Table 5.

### Determination of Colour Strength and Filter Pressure Value

For pigment preparations C-1 to C-44, the colour strength compared to pigment C and the filter pressure value were determined according to protocols 1 and 2 indicated below. The values can also be found in Table 5.

TABLE 5
Pigment preparations with pigment C

| | | | Grams of aliphatic | | | |
|---|---|---|---|---|---|---|
| | | According | carboxylic acid | Aliphatic | Colour | |
| | Pigment | to the | B) or mixture per | carboxylic acid | strength | FPV |
| Example | preparation | invention | mole of pigment | B) or mixture | [%] | [bar/g] |
| 94 | C-1 | no | 70 | Pristerene ® 4910 | 99 | 15.6 |
| 95 | C-2 | no | 150 | Pristerene ® 4910 | 97 | 15.8 |
| 96 | C-3 | no | 250 | Pristerene ® 4910 | 95 | 15.6 |
| 97 | C-4 | no | 50 | Pristerene ® 4911 | 99 | 15.9 |
| 98 | C-5 | no | 210 | Pristerene ® 4911 | 97 | 16.0 |
| 99 | C-6 | no | 235 | Pristerene ® 4911 | 94 | 16.2 |
| 100 | C-7 | no | 50 | Pristerene ® 9429 | 98 | 16.2 |
| 101 | C-8 | no | 150 | Pristerene ® 9429 | 95 | 16.0 |
| 102 | C-9 | no | 235 | Pristerene ® 9429 | 93 | 15.8 |
| 103 | C-10 | no | 70 | Pristerene ® 4922 | 99 | 15.8 |
| 104 | C-11 | no | 180 | Pristerene ® 4922 | 95 | 16.0 |
| 105 | C-12 | no | 280 | Pristerene ® 4922 | 91 | 16.2 |
| 106 | C-13 | no | 150 | caprylic acid | 97 | 15.9 |
| 107 | C-14 | no | 235 | caprylic acid | 92 | 16.3 |
| 108 | C-15 | no | 150 | lignoceric acid | 95 | 15.6 |
| 109 | C-16 | no | 70 | lignoceric acid | 98 | 15.6 |
| 110 | C-17 | no | 250 | lignoceric acid | 93 | 15.9 |
| 111 | C-18 | no | 70 | nervonic acid | 99 | 16.0 |
| 112 | C-19 | no | 150 | nervonic acid | 97 | 16.2 |
| 113 | C-20 | no | 210 | nervonic acid | 95 | 15.8 |
| 114 | C-21 | no | 100 | capric acid | 97 | 16.3 |
| 115 | C-22 | no | 150 | capric acid | 95 | 15.9 |
| 116 | C-23 | no | 250 | capric acid | 92 | 15.8 |
| 117 | C-24 | no | 70 | lauric acid | 98 | 15.8 |
| 118 | C-25 | no | 120 | lauric acid | 96 | 15.8 |
| 119 | C-26 | no | 235 | lauric acid | 94 | 16.2 |
| 120 | C-27 | no | 50 | myristic acid | 99 | 15.6 |
| 121 | C-28 | no | 180 | myristic acid | 96 | 15.8 |
| 122 | C-29 | no | 250 | myristic acid | 94 | 16.2 |
| 123 | C-30 | no | 70 | palmitic acid | 99 | 15.8 |
| 124 | C-31 | no | 210 | palmitic acid | 95 | 16.4 |
| 125 | C-32 | no | 250 | palmitic acid | 92 | 16.5 |
| 126 | C-33 | no | 70 | stearic acid | 98 | 15.9 |
| 127 | C-34 | no | 150 | stearic acid | 95 | 16.0 |
| 128 | C-35 | no | 235 | stearic acid | 93 | 16.2 |
| 129 | C-36 | no | 70 | behenic acid | 97 | 16.0 |
| 130 | C-37 | no | 150 | behenic acid | 95 | 16.3 |
| 131 | C-38 | no | 235 | behenic acid | 92 | 16.1 |
| 132 | C-39 | no | 70 | oleic acid | 99 | 15.8 |
| 133 | C-40 | no | 210 | oleic acid | 97 | 15.9 |
| 134 | C-41 | no | 250 | oleic acid | 95 | 16.0 |
| 135 | C-42 | no | 70 | undecylenic acid | 98 | 15.8 |
| 136 | C-43 | no | 210 | undecylenic acid | 95 | 15.8 |
| 137 | C-44 | no | 280 | undecylenic acid | 92 | 16.2 |

### Example 138: Production of Pigment Preparation D-1 (not in Accordance with the Invention)

An aqueous suspension of pigment D, as obtained after step c) of Example 4, was admixed with 70 g of Pristerene® 4910 and stirred for 60 minutes. Aqueous potassium hydroxide solution was subsequently used to establish a pH of 5. The pigment preparation was then isolated on a suction filter, washed and dried at 80° C. in a vacuum drying oven and ground in a customary laboratory mill for around 2 minutes. (=pigment preparation D-1)

### Examples 139 to 171: Production of Pigment Preparations D-2 to D-34 (not in Accordance with the Invention and According to the Invention)

Analogously to Example 138, pigment preparations according to the invention and not in accordance with the invention were produced in Examples 139 to 171. In each case, an aqueous suspension of the pigment D, as obtained after step c) of Example 4, was admixed with different aliphatic carboxylic acids B) or mixtures thereof in different amounts, as indicated in Table 5.

### Determination of Colour Strength and Filter Pressure Value

For pigment preparations D-1 to D-34, the colour strength compared to pigment D and the filter pressure value were determined in accordance with protocols 1 and 2 below. The values can also be found in Table 6.

TABLE 6
Pigment preparations with pigment D

| | | | Grams of aliphatic | | | |
|---|---|---|---|---|---|---|
| | | According | carboxylic acid | Aliphatic | Colour | |
| | Pigment | to the | B) or mixture per | carboxylic acid | strength | FPV |
| Example | preparation | invention | mole of pigment | B) or mixture | [%] | [bar/g] |
| 138 | D-1 | no | 70 | Pristerene ® 4910 | 101 | 15.3 |
| 139 | D-2 | yes | 150 | Pristerene ® 4910 | 106 | 3.5 |
| 140 | D-3 | yes | 250 | Pristerene ® 4910 | 106 | 3.4 |
| 141 | D-4 | no | 280 | Pristerene ® 4910 | 98 | 3.5 |
| 142 | D-5 | no | 50 | caprylic acid | 98 | 15.6 |
| 143 | D-6 | no | 150 | caprylic acid | 98 | 15.6 |
| 144 | D-7 | no | 280 | caprylic acid | 90 | 16.2 |
| 145 | D-8 | no | 70 | nervonic acid | 100 | 16.2 |
| 146 | D-9 | no | 150 | nervonic acid | 95 | 15.6 |
| 147 | D-10 | no | 235 | nervonic acid | 92 | 15.1 |
| 148 | D-11 | no | 70 | capric acid | 98 | 15.6 |
| 149 | D-12 | yes | 100 | capric acid | 107 | 3.6 |
| 150 | D-13 | yes | 210 | capric acid | 106 | 3.5 |
| 151 | D-14 | no | 280 | capric acid | 95 | 3.6 |
| 152 | D-15 | no | 70 | palmitic acid | 98 | 15.2 |
| 153 | D-16 | yes | 100 | palmitic acid | 107 | 3.0 |
| 154 | D-17 | yes | 250 | palmitic acid | 106 | 3.2 |
| 155 | D-18 | no | 280 | palmitic acid | 95 | 3.5 |
| 156 | D-19 | no | 70 | stearic acid | 99 | 15.4 |
| 157 | D-20 | yes | 150 | stearic acid | 108 | 3.4 |
| 158 | D-21 | yes | 250 | stearic acid | 106 | 3.5 |
| 159 | D-22 | no | 280 | stearic acid | 97 | 3.8 |
| 160 | D-23 | no | 70 | behenic acid | 98 | 15.6 |
| 161 | D-24 | yes | 100 | behenic acid | 106 | 3.1 |
| 162 | D-25 | yes | 180 | behenic acid | 106 | 3.0 |
| 163 | D-26 | no | 280 | behenic acid | 95 | 3.2 |
| 164 | D-27 | no | 70 | oleic acid | 98 | 15.6 |
| 165 | D-28 | yes | 100 | oleic acid | 107 | 3.1 |
| 166 | D-29 | yes | 250 | oleic acid | 106 | 3.2 |
| 167 | D-30 | no | 280 | oleic acid | 95 | 3.5 |
| 168 | D-31 | no | 70 | undecylenic acid | 98 | 14.9 |
| 169 | D-32 | yes | 150 | undecylenic acid | 105 | 2.9 |
| 170 | D-33 | yes | 210 | undecylenic acid | 105 | 2.8 |
| 171 | D-34 | no | 280 | undecylenic acid | 92 | 3.2 |

### Example 172: Production of Pigment Preparation E-1 (not in Accordance with the Invention)

An aqueous suspension of pigment E, as obtained after step c) of Example 5, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation E-1)

### Examples 173 to 240: Production of Pigment Preparations E-2 to E-70 (not in Accordance with the Invention and According to the Invention)

Analogously to Example 172, pigment preparations E-2 to E-81, according to the invention and not in accordance with the invention, were produced in Examples 173 to 240. In each case, an aqueous suspension of the pigment E, as obtained after step c) of Example 5, was admixed with different aliphatic carboxylic acids B) or mixtures thereof in different amounts, as indicated in Table 7.

### Determination of Colour Strength and Filter Pressure Value

For pigment preparations E-1 to E-70, the colour strength compared to pigment E and the filter pressure value were determined in accordance with protocols 1 and 2 indicated below. The values can also be found in Table 7.

TABLE 7
Pigment preparations with pigment E

| | | | Grams of aliphatic | | | |
|---|---|---|---|---|---|---|
| | | According | carboxylic acid | Aliphatic | Colour | |
| | Pigment | to the | B) or mixture per | carboxylic acid | strength | FPV |
| Example | preparation | invention | mole of pigment | B) or mixture | [%] | [bar/g] |
| 172 | E-1 | no | 70 | Pristerene ® 4910 | 98 | 15.9 |
| 173 | E-2 | yes | 100 | Pristerene ® 4910 | 109 | 3.5 |
| 174 | E-3 | yes | 150 | Pristerene ® 4910 | 112 | 3.5 |
| 175 | E-4 | yes | 250 | Pristerene ® 4910 | 108 | 3.4 |
| 176 | E-5 | no | 280 | Pristerene ® 4910 | 99 | 3.6 |
| 177 | E-6 | no | 70 | Pristerene ® 4911 | 98 | 15.6 |
| 178 | E-7 | yes | 100 | Pristerene ® 4911 | 108 | 3.2 |
| 179 | E-8 | yes | 150 | Pristerene ® 4911 | 111 | 3.1 |
| 180 | E-10 | yes | 250 | Pristerene ® 4911 | 106 | 3.3 |
| 181 | E-11 | no | 280 | Pristerene ® 4911 | 96 | 3.3 |
| 182 | E-12 | no | 70 | Pristerene ® 9429 | 98 | 15.6 |
| 183 | E-13 | yes | 100 | Pristerene ® 9429 | 108 | 2.9 |
| 184 | E-14 | yes | 150 | Pristerene ® 9429 | 110 | 2.9 |
| 185 | E-15 | yes | 250 | Pristerene ® 9429 | 108 | 3.1 |
| 186 | E-16 | no | 280 | Pristerene ® 9429 | 96 | 3.6 |
| 187 | E-17 | no | 70 | Pristerene ® 4922 | 98 | 15.1 |
| 188 | E-18 | yes | 100 | Pristerene ® 4922 | 105 | 3.6 |
| 189 | E-19 | yes | 150 | Pristerene ® 4922 | 108 | 3.5 |
| 190 | E-20 | yes | 250 | Pristerene ® 4922 | 106 | 3.5 |
| 191 | E-21 | no | 280 | Pristerene ® 4922 | 98 | 3.6 |
| 192 | E-22 | no | 70 | caprylic acid | 98 | 15.6 |
| 193 | E-23 | no | 150 | caprylic acid | 95 | 15.1 |
| 194 | E-24 | no | 250 | caprylic acid | 90 | 15.3 |
| 195 | E-25 | no | 100 | lignoceric acid | 98 | 16.2 |
| 196 | E-26 | no | 150 | lignoceric acid | 96 | 15.9 |
| 197 | E-27 | no | 210 | lignoceric acid | 94 | 15.6 |
| 198 | E-28 | no | 100 | nervonic acid | 96 | 15.4 |
| 199 | E-29 | no | 150 | nervonic acid | 95 | 15.2 |
| 200 | E-30 | no | 250 | nervonic acid | 93 | 15.6 |
| 201 | E-31 | no | 70 | capric acid | 98 | 15.3 |
| 202 | E-32 | yes | 100 | capric acid | 106 | 2.9 |
| 203 | E-33 | yes | 150 | capric acid | 107 | 2.8 |
| 204 | E-34 | yes | 250 | capric acid | 105 | 2.9 |
| 205 | E-35 | no | 280 | capric acid | 98 | 3.1 |
| 206 | E-36 | no | 70 | lauric acid | 98 | 15.9 |
| 207 | E-37 | yes | 100 | lauric acid | 105 | 3.6 |
| 208 | E-38 | yes | 150 | lauric acid | 106 | 3.4 |
| 209 | E-39 | yes | 250 | lauric acid | 105 | 3.5 |
| 210 | E-40 | no | 280 | lauric acid | 98 | 3.6 |
| 211 | E-41 | no | 70 | myristic acid | 97 | 15.6 |
| 212 | E-42 | yes | 100 | myristic acid | 106 | 3.2 |
| 213 | E-43 | yes | 150 | myristic acid | 106 | 3.3 |
| 214 | E-44 | yes | 250 | myristic acid | 105 | 3.3 |
| 215 | E-45 | no | 280 | myristic acid | 98 | 3.4 |
| 216 | E-46 | no | 70 | palmitic acid | 96 | 15.6 |
| 217 | E-47 | yes | 100 | palmitic acid | 106 | 3.1 |
| 218 | E-48 | yes | 150 | palmitic acid | 107 | 3.0 |
| 219 | E-49 | yes | 250 | palmitic acid | 105 | 3.1 |
| 220 | E-50 | no | 280 | palmitic acid | 98 | 3.3 |
| 221 | E-51 | no | 70 | stearic acid | 98 | 15.1 |
| 222 | E-52 | yes | 100 | stearic acid | 106 | 3.2 |
| 223 | E-53 | yes | 150 | stearic acid | 107 | 3.1 |
| 224 | E-54 | yes | 250 | stearic acid | 105 | 3.2 |
| 225 | E-55 | no | 280 | stearic acid | 98 | 3.3 |
| 226 | E-56 | no | 70 | behenic acid | 97 | 15.6 |
| 227 | E-57 | yes | 100 | behenic acid | 104 | 3.5 |
| 228 | E-58 | yes | 150 | behenic acid | 105 | 3.5 |
| 229 | E-59 | yes | 250 | behenic acid | 104 | 3.6 |
| 230 | E-60 | no | 280 | behenic acid | 96 | 3.6 |
| 231 | E-61 | no | 70 | oleic acid | 97 | 15.9 |
| 232 | E-62 | yes | 100 | oleic acid | 104 | 3.1 |
| 233 | E-63 | yes | 150 | oleic acid | 106 | 3.2 |
| 234 | E-64 | yes | 250 | oleic acid | 104 | 3.4 |
| 235 | E-65 | no | 280 | oleic acid | 98 | 3.5 |
| 236 | E-66 | no | 70 | undecylenic acid | 96 | 16.1 |
| 237 | E-67 | yes | 100 | undecylenic acid | 103 | 3.8 |
| 238 | E-68 | yes | 150 | undecylenic acid | 105 | 3.5 |
| 239 | E-69 | yes | 250 | undecylenic acid | 104 | 3.8 |
| 240 | E-70 | no | 280 | undecylenic acid | 95 | 3.8 |

### Example 241: Production of Pigment Preparation F-1 (not in Accordance with the Invention)

An aqueous suspension of pigment F, as obtained after step c) of Example 6, was admixed with 70 g of Pristerene 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation F-1)

### Examples 242 to 274: Production of Pigment Preparations F-2 to F-33 (not in Accordance with the Invention and According to the Invention)

Analogously to Example 242, pigment preparations F-2 to F-33, according to the invention and not in accordance with the invention, were produced in Examples 242 to 274. In each case, an aqueous suspension of the pigment F, as obtained after step c) of Example 6, was admixed with different aliphatic carboxylic acids B) or mixtures thereof in different amounts, as indicated in Table 8.

### Determination of Colour Strength and Filter Pressure Value

For pigment preparations F-1 to F-33, the colour strength compared to pigment F and the filter pressure value were determined in accordance with protocols 1 and 2 indicated below. The values can also be found in Table 8.

TABLE 8
Pigment preparations with pigment F

| | | | Grams of aliphatic | | | |
|---|---|---|---|---|---|---|
| | | According | carboxylic acid | Aliphatic | Colour | |
| | Pigment | to the | B) or mixture per | carboxylic acid | strength | FPV |
| Example | preparation | invention | mole of pigment | B) or mixture | [%] | [bar/g] |
| 241 | F-1 | no | 70 | Pristerene ® 4910 | 98 | 15.6 |
| 242 | F-2 | yes | 150 | Pristerene ® 4910 | 114 | 2.9 |
| 243 | F-3 | yes | 250 | Pristerene ® 4910 | 115 | 2.9 |
| 244 | F-4 | no | 280 | Pristerene ® 4910 | 99 | 3.1 |
| 245 | F-5 | no | 70 | caprylic acid | 97 | 15.6 |
| 246 | F-6 | no | 150 | caprylic acid | 95 | 15.9 |
| 247 | F-7 | no | 235 | caprylic acid | 94 | 16.2 |
| 248 | F-8 | no | 100 | nervonic acid | 98 | 16.2 |
| 249 | F-9 | no | 150 | nervonic acid | 95 | 16.2 |
| 250 | F-10 | no | 210 | nervonic acid | 92 | 16.8 |
| 251 | F-11 | no | 70 | capric acid | 98 | 16.2 |
| 252 | F-12 | yes | 150 | capric acid | 113 | 3.2 |
| 253 | F-13 | yes | 235 | capric acid | 112 | 3.3 |
| 254 | F-14 | no | 280 | capric acid | 95 | 3.3 |
| 255 | F-15 | no | 70 | palmitic acid | 95 | 15.6 |
| 256 | F-16 | yes | 100 | palmitic acid | 114 | 3.2 |
| 257 | F-17 | yes | 210 | palmitic acid | 113 | 3.3 |
| 258 | F-18 | no | 280 | palmitic acid | 99 | 3.4 |
| 259 | F-19 | no | 70 | stearic acid | 96 | 15.2 |
| 260 | F-20 | yes | 150 | stearic acid | 115 | 3.1 |
| 261 | F-21 | yes | 210 | stearic acid | 114 | 3.1 |
| 262 | F-22 | no | 280 | stearic acid | 98 | 3.3 |
| 263 | F-23 | no | 70 | behenic acid | 95 | 15.2 |
| 264 | F-24 | yes | 150 | behenic acid | 112 | 3.4 |
| 265 | F-25 | yes | 210 | behenic acid | 111 | 3.5 |
| 266 | F-26 | no | 280 | behenic acid | 95 | 3.6 |
| 267 | F-27 | no | 70 | oleic acid | 95 | 15.9 |
| 268 | F-28 | yes | 150 | oleic acid | 113 | 3.5 |
| 269 | F-29 | yes | 250 | oleic acid | 112 | 3.6 |
| 270 | F-30 | no | 280 | oleic acid | 93 | 3.6 |
| 271 | F-30 | no | 70 | undecylenic acid | 94 | 16.1 |
| 272 | F-31 | yes | 120 | undecylenic acid | 113 | 3.5 |
| 273 | F-32 | yes | 210 | undecylenic acid | 112 | 3.6 |
| 274 | F-33 | no | 280 | undecylenic acid | 95 | 3.6 |

### Example 275: Production of Pigment Preparation G-1 (not in Accordance with the Invention)

An aqueous suspension of pigment G, as obtained after step c) of Example 7, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation G-1)

### Examples 276 to 355: Production of Pigment Preparations G-2 to G-81 (not in Accordance with the Invention and According to the Invention)

Analogously to Example 275, pigment preparations G-2 to G-81, according to the invention and not in accordance with the invention, were produced in Examples 276 to 355. In each case, an aqueous suspension of the pigment G, as obtained after step c) of Example 7, was admixed with different aliphatic carboxylic acids B) or mixtures thereof in different amounts, as indicated in Table 9.

### Determination of Colour Strength and Filter Pressure Value

For pigment preparations G-1 to G-81, the colour strength compared to pigment G and the filter pressure value were determined in accordance with protocols 1 and 2 indicated below. The values can also be found in Table 9.

TABLE 9
Pigment preparations with pigment G

| | | | Grams of aliphatic | | | |
|---|---|---|---|---|---|---|
| | | According | carboxylic acid | Aliphatic | Colour | |
| | Pigment | to the | B) or mixture per | carboxylic acid | strength | FPV |
| Example | preparation | invention | mole of pigment | B) or mixture | [%] | [bar/g] |
| 275 | G-1 | no | 70 | Pristerene ® 4910 | 95 | 15.6 |
| 276 | G-2 | yes | 100 | Pristerene ® 4910 | 133 | 3.2 |
| 277 | G-3 | yes | 150 | Pristerene ® 4910 | 135 | 3.2 |
| 278 | G-4 | yes | 180 | Pristerene ® 4910 | 133 | 3.1 |
| 279 | G-5 | yes | 250 | Pristerene ® 4910 | 132 | 3.2 |
| 280 | G-6 | no | 280 | Pristerene ® 4910 | 99 | 3.2 |
| 281 | G-7 | no | 70 | Pristerene ® 4911 | 94 | 15.6 |
| 282 | G-8 | yes | 100 | Pristerene ® 4911 | 134 | 3.2 |
| 283 | G-9 | yes | 120 | Pristerene ® 4911 | 134 | 3.1 |
| 284 | G-10 | yes | 180 | Pristerene ® 4911 | 133 | 3.2 |
| 285 | G-11 | yes | 250 | Pristerene ® 4911 | 132 | 3.2 |
| 286 | G-12 | no | 280 | Pristerene ® 4911 | 98 | 3.3 |
| 287 | G-13 | no | 70 | Pristerene ® 9429 | 98 | 15.6 |
| 288 | G-14 | yes | 100 | Pristerene ® 9429 | 133 | 3.2 |
| 289 | G-15 | yes | 150 | Pristerene ® 9429 | 135 | 3.2 |
| 290 | G-16 | yes | 180 | Pristerene ® 9429 | 133 | 3.2 |
| 291 | G-17 | yes | 250 | Pristerene ® 9429 | 132 | 3.1 |
| 292 | G-18 | no | 280 | Pristerene ® 9429 | 98 | 3.2 |
| 293 | G-19 | no | 70 | Pristerene ® 4922 | 96 | 15.6 |
| 294 | G-20 | yes | 100 | Pristerene ® 4922 | 125 | 3.2 |
| 295 | G-21 | yes | 120 | Pristerene ® 4922 | 135 | 3.2 |
| 296 | G-22 | yes | 180 | Pristerene ® 4922 | 134 | 3.3 |
| 297 | G-23 | yes | 250 | Pristerene ® 4922 | 130 | 3.2 |
| 298 | G-24 | no | 280 | Pristerene ® 4922 | 96 | 3.3 |
| 299 | G-25 | no | 100 | caprylic acid | 93 | 15.6 |
| 300 | G-26 | no | 150 | caprylic acid | 90 | 15.2 |
| 301 | G-27 | no | 250 | caprylic acid | 89 | 15.3 |
| 302 | G-28 | no | 100 | lignoceric acid | 92 | 15.2 |
| 303 | G-29 | no | 150 | lignoceric acid | 90 | 15.3 |
| 304 | G-30 | no | 210 | lignoceric acid | 87 | 15.3 |
| 305 | G-31 | no | 70 | nervonic acid | 94 | 15.3 |
| 306 | G-32 | no | 150 | nervonic acid | 90 | 15.4 |
| 307 | G-33 | no | 210 | nervonic acid | 86 | 15.6 |
| 308 | G-34 | no | 70 | capric acid | 95 | 15.6 |
| 309 | G-35 | yes | 100 | capric acid | 122 | 3.6 |
| 310 | G-36 | yes | 150 | capric acid | 124 | 3.6 |
| 311 | G-37 | yes | 180 | capric acid | 124 | 3.5 |
| 312 | G-38 | yes | 250 | capric acid | 119 | 3.5 |
| 313 | G-39 | no | 280 | capric acid | 96 | 3.5 |
| 314 | G-40 | no | 70 | lauric acid | 95 | 15.4 |
| 315 | G-41 | yes | 100 | lauric acid | 122 | 3.4 |
| 316 | G-42 | yes | 120 | lauric acid | 124 | 3.4 |
| 317 | G-43 | yes | 180 | lauric acid | 120 | 3.4 |
| 318 | G-44 | yes | 250 | lauric acid | 118 | 3.4 |
| 319 | G-45 | no | 280 | lauric acid | 96 | 3.4 |
| 320 | G-46 | no | 70 | myristic acid | 96 | 15.6 |
| 321 | G-47 | yes | 100 | myristic acid | 122 | 3.6 |
| 322 | G-48 | yes | 120 | myristic acid | 124 | 3.5 |
| 323 | G-49 | yes | 180 | myristic acid | 124 | 3.5 |
| 324 | G-50 | yes | 250 | myristic acid | 118 | 3.4 |
| 325 | G-51 | no | 280 | myristic acid | 95 | 3.4 |
| 326 | G-52 | no | 70 | palmitic acid | 94 | 15.2 |
| 327 | G-53 | yes | 100 | palmitic acid | 123 | 3.2 |
| 328 | G-54 | yes | 150 | palmitic acid | 125 | 3.2 |
| 329 | G-55 | yes | 180 | palmitic acid | 125 | 3.3 |
| 330 | G-56 | yes | 250 | palmitic acid | 120 | 3.3 |
| 331 | G-57 | no | 280 | palmitic acid | 96 | 3.3 |
| 332 | G-58 | no | 70 | stearic acid | 95 | 15.2 |
| 333 | G-59 | yes | 100 | stearic acid | 122 | 3.2 |
| 334 | G-60 | yes | 120 | stearic acid | 124 | 3.2 |
| 335 | G-61 | yes | 180 | stearic acid | 124 | 3.1 |
| 336 | G-62 | yes | 250 | stearic acid | 120 | 3.1 |
| 337 | G-63 | no | 280 | stearic acid | 96 | 3.2 |
| 338 | G-64 | no | 70 | behenic acid | 96 | 15.3 |
| 339 | G-65 | yes | 100 | behenic acid | 118 | 3.5 |
| 340 | G-66 | yes | 150 | behenic acid | 119 | 3.5 |
| 341 | G-67 | yes | 180 | behenic acid | 120 | 3.4 |
| 342 | G-68 | yes | 250 | behenic acid | 118 | 3.4 |
| 343 | G-69 | no | 280 | behenic acid | 96 | 3.4 |
| 344 | G-70 | no | 70 | oleic acid | 95 | 16.5 |
| 345 | G-71 | yes | 100 | oleic acid | 115 | 3.6 |
| 346 | G-72 | yes | 150 | oleic acid | 116 | 3.6 |
| 347 | G-73 | yes | 180 | oleic acid | 117 | 3.5 |
| 348 | G-74 | yes | 250 | oleic acid | 114 | 3.5 |
| 349 | G-75 | no | 280 | oleic acid | 95 | 3.6 |
| 350 | G-76 | no | 70 | undecylenic acid | 95 | 16.2 |
| 351 | G-77 | yes | 100 | undecylenic acid | 112 | 3.4 |
| 352 | G-78 | yes | 120 | undecylenic acid | 113 | 3.5 |
| 353 | G-79 | yes | 180 | undecylenic acid | 115 | 3.4 |
| 354 | G-80 | yes | 250 | undecylenic acid | 113 | 3.4 |
| 355 | G-81 | no | 280 | undecylenic acid | 93 | 3.5 |

### Example 356: Production of Pigment Preparation H-1 (not in Accordance with the Invention)

An aqueous suspension of pigment H, as obtained after step c) of Example 8, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation H-1)

### Examples 357 to 436: Production of Pigment Preparations H-2 to H-81 (not in Accordance with the Invention and According to the Invention)

Analogously to Example 356, pigment preparations H-2 to H-81, according to the invention and not in accordance with the invention, were produced in Examples 357 to 436. In each case, an aqueous suspension of the pigment H as obtained after step c) of Example 8 was admixed with different aliphatic carboxylic acids B) or mixtures thereof in different amounts, as indicated in Table 10.

### Determination of Colour Strength and Filter Pressure Value

For pigment preparations H-1 to H-81, the colour strength compared to pigment H and the filter pressure value were determined in accordance with protocols 1 and 2 indicated below. The values can also be found in Table 10.

TABLE 10
Pigment preparations with pigment H

| | | | Grams of aliphatic | | | |
|---|---|---|---|---|---|---|
| | | According | carboxylic acid | Aliphatic | Colour | |
| | Pigment | to the | B) or mixture per | carboxylic acid | strength | FPV |
| Example | preparation | invention | mole of pigment | B) or mixture | [%] | [bar/g] |
| 356 | H-1 | no | 70 | Pristerene ® 4910 | 94 | 15.6 |
| 357 | H-2 | yes | 100 | Pristerene ® 4910 | 110 | 2.9 |
| 358 | H-3 | yes | 120 | Pristerene ® 4910 | 115 | 3.0 |
| 359 | H-4 | yes | 180 | Pristerene ® 4910 | 115 | 3.0 |
| 360 | H-5 | yes | 250 | Pristerene ® 4910 | 110 | 3.1 |
| 361 | H-6 | no | 280 | Pristerene ® 4910 | 96 | 3.1 |
| 362 | H-7 | no | 70 | Pristerene ® 4911 | 94 | 15.2 |
| 363 | H-8 | yes | 100 | Pristerene ® 4911 | 111 | 2.9 |
| 364 | H-9 | yes | 120 | Pristerene ® 4911 | 116 | 3.0 |
| 365 | H-10 | yes | 180 | Pristerene ® 4911 | 115 | 3.1 |
| 366 | H-11 | yes | 250 | Pristerene ® 4911 | 110 | 3.1 |
| 367 | H-12 | no | 280 | Pristerene ® 4911 | 96 | 3.1 |
| 368 | H-13 | no | 70 | Pristerene ® 9429 | 95 | 16.1 |
| 369 | H-14 | yes | 100 | Pristerene ® 9429 | 110 | 3.2 |
| 370 | H-15 | yes | 150 | Pristerene ® 9429 | 115 | 3.2 |
| 371 | H-16 | yes | 180 | Pristerene ® 9429 | 115 | 3.2 |
| 372 | H-17 | yes | 250 | Pristerene ® 9429 | 110 | 3.3 |
| 373 | H-18 | no | 280 | Pristerene ® 9429 | 96 | 3.3 |
| 374 | H-19 | no | 70 | Pristerene ® 4922 | 95 | 15.8 |
| 375 | H-20 | yes | 100 | Pristerene ® 4922 | 111 | 2.9 |
| 376 | H-21 | yes | 120 | Pristerene ® 4922 | 114 | 2.9 |
| 377 | H-22 | yes | 180 | Pristerene ® 4922 | 114 | 2.9 |
| 378 | H-23 | yes | 250 | Pristerene ® 4922 | 111 | 3.0 |
| 379 | H-24 | no | 280 | Pristerene ® 4922 | 95 | 3.0 |
| 380 | H-25 | no | 100 | caprylic acid | 95 | 15.6 |
| 381 | H-26 | no | 150 | caprylic acid | 90 | 15.8 |
| 382 | H-27 | no | 250 | caprylic acid | 87 | 15.6 |
| 383 | H-28 | no | 100 | lignoceric acid | 94 | 15.3 |
| 384 | H-29 | no | 150 | lignoceric acid | 91 | 15.4 |
| 385 | H-30 | no | 210 | lignoceric acid | 88 | 15.3 |
| 386 | H-31 | no | 70 | nervonic acid | 94 | 15.6 |
| 387 | H-32 | no | 150 | nervonic acid | 90 | 15.4 |
| 388 | H-33 | no | 210 | nervonic acid | 89 | 15.5 |
| 389 | H-34 | no | 70 | capric acid | 95 | 15.4 |
| 390 | H-35 | yes | 100 | capric acid | 109 | 3.3 |
| 391 | H-36 | yes | 150 | capric acid | 112 | 3.3 |
| 392 | H-37 | yes | 180 | capric acid | 112 | 3.4 |
| 393 | H-38 | yes | 250 | capric acid | 111 | 3.4 |
| 394 | H-39 | no | 280 | capric acid | 96 | 3.4 |
| 395 | H-40 | no | 70 | lauric acid | 95 | 15.2 |
| 396 | H-41 | yes | 100 | lauric acid | 109 | 3.2 |
| 397 | H-42 | yes | 120 | lauric acid | 109 | 3.2 |
| 398 | H-43 | yes | 180 | lauric acid | 108 | 3.3 |
| 399 | H-44 | yes | 250 | lauric acid | 107 | 3.1 |
| 400 | H-45 | no | 280 | lauric acid | 94 | 3.2 |
| 401 | H-46 | no | 70 | myristic acid | 94 | 15.9 |
| 402 | H-47 | yes | 100 | myristic acid | 104 | 3.1 |
| 403 | H-48 | yes | 120 | myristic acid | 105 | 3.1 |
| 404 | H-49 | yes | 180 | myristic acid | 105 | 3.2 |
| 405 | H-50 | yes | 250 | myristic acid | 104 | 3.2 |
| 406 | H-51 | no | 280 | myristic acid | 96 | 3.2 |
| 407 | H-52 | no | 70 | palmitic acid | 95 | 15.9 |
| 408 | H-53 | yes | 100 | palmitic acid | 111 | 2.9 |
| 409 | H-54 | yes | 150 | palmitic acid | 112 | 2.9 |
| 410 | H-55 | yes | 180 | palmitic acid | 112 | 2.9 |
| 411 | H-56 | yes | 250 | palmitic acid | 110 | 2.9 |
| 412 | H-57 | no | 280 | palmitic acid | 96 | 3.0 |
| 413 | H-58 | no | 70 | stearic acid | 96 | 15.3 |
| 414 | H-59 | yes | 100 | stearic acid | 112 | 3.1 |
| 415 | H-60 | yes | 120 | stearic acid | 113 | 3.1 |
| 416 | H-61 | yes | 180 | stearic acid | 113 | 3.0 |
| 417 | H-62 | yes | 250 | stearic acid | 112 | 3.1 |
| 418 | H-63 | no | 280 | stearic acid | 96 | 3.1 |
| 419 | H-64 | no | 70 | behenic acid | 95 | 15.2 |
| 420 | H-65 | yes | 100 | behenic acid | 109 | 3.3 |
| 421 | H-66 | yes | 150 | behenic acid | 110 | 3.4 |
| 422 | H-67 | yes | 180 | behenic acid | 110 | 3.3 |
| 423 | H-68 | yes | 250 | behenic acid | 109 | 3.3 |
| 424 | H-69 | no | 280 | behenic acid | 95 | 3.3 |
| 425 | H-70 | no | 70 | oleic acid | 95 | 15.6 |
| 426 | H-71 | yes | 100 | oleic acid | 109 | 3.4 |
| 427 | H-72 | yes | 150 | oleic acid | 109 | 3.3 |
| 428 | H-73 | yes | 180 | oleic acid | 108 | 3.3 |
| 429 | H-74 | yes | 250 | oleic acid | 108 | 3.3 |
| 430 | H-75 | no | 280 | oleic acid | 96 | 3.4 |
| 431 | H-76 | no | 70 | undecylenic acid | 95 | 15.8 |
| 432 | H-77 | yes | 100 | undecylenic acid | 109 | 3.4 |
| 433 | H-78 | yes | 120 | undecylenic acid | 109 | 3.3 |
| 434 | H-79 | yes | 180 | undecylenic acid | 108 | 3.3 |
| 435 | H-80 | yes | 250 | undecylenic acid | 107 | 3.4 |
| 436 | H-81 | no | 280 | undecylenic acid | 95 | 3.4 |

### Example 437: Production of Pigment Preparation I-1 (not in Accordance with the Invention)

An aqueous suspension of pigment I, as obtained after step c) of Example 9, was mixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation 1-1)

### Examples 438 to 468: Production of Pigment Preparations I-2 to 1-32 (not in Accordance with the Invention and According to the Invention)

Analogously to Example 437, pigment preparations 1-2 to 1-32, according to the invention and not in accordance with the invention, were produced in Examples 438 to 468. In each case, an aqueous suspension of pigment I, as obtained after step c) of Example 9, was admixed with different aliphatic carboxylic acids B) or mixtures thereof in different amounts, as indicated in Table 11.

### Determination of Colour Strength and Filter Pressure Value

For the pigment preparations I-1 to 1-32, the colour strength compared to pigment I and the filter pressure value were determined in accordance with protocols 1 and 2 below. The values can also be found in Table 11.

TABLE 11
Pigment preparations with pigment I

| | | | Grams of | | | |
|---|---|---|---|---|---|---|
| | | | aliphatic | | | |
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 437 | I-1 | no | 70 | Pristerene ® 4910 | 94 | 15.2 |
| 438 | I-2 | yes | 100 | Pristerene ® 4910 | 108 | 3.0 |
| 439 | I-3 | yes | 210 | Pristerene ® 4910 | 108 | 3.0 |
| 440 | I-4 | no | 280 | Pristerene ® 4910 | 96 | 3.1 |
| 441 | I-5 | no | 150 | caprylic acid | 96 | 15.6 |
| 442 | I-6 | no | 210 | caprylic acid | 95 | 15.3 |
| 443 | I-7 | no | 150 | nervonic acid | 94 | 15.3 |
| 444 | I-8 | no | 210 | nervonic acid | 93 | 15.9 |
| 445 | I-9 | no | 70 | capric acid | 95 | 15.8 |
| 446 | I-10 | yes | 150 | capric acid | 107 | 3.3 |
| 447 | I-11 | yes | 250 | capric acid | 106 | 3.2 |
| 448 | I-12 | no | 280 | capric acid | 94 | 3.2 |
| 449 | I-13 | no | 70 | palmitic acid | 96 | 15.2 |
| 450 | I-14 | yes | 100 | palmitic acid | 109 | 3.0 |
| 451 | I-15 | yes | 210 | palmitic acid | 109 | 3.0 |
| 452 | I-16 | no | 280 | palmitic acid | 96 | 3.1 |
| 453 | I-17 | no | 70 | stearic acid | 95 | 15.6 |
| 454 | I-18 | yes | 150 | stearic acid | 108 | 3.0 |
| 455 | I-19 | yes | 250 | stearic acid | 108 | 3.0 |
| 456 | I-20 | no | 280 | stearic acid | 94 | 3.1 |
| 457 | I-21 | no | 70 | behenic acid | 95 | 15.7 |
| 458 | I-22 | yes | 100 | behenic acid | 107 | 3.2 |
| 459 | I-23 | yes | 210 | behenic acid | 107 | 3.2 |
| 460 | I-24 | no | 280 | behenic acid | 94 | 3.2 |
| 461 | I-25 | no | 70 | oleic acid | 94 | 15.1 |
| 462 | I-26 | yes | 120 | oleic acid | 106 | 3.3 |
| 463 | I-27 | yes | 210 | oleic acid | 106 | 3.3 |
| 464 | I-28 | no | 280 | oleic acid | 93 | 3.3 |
| 465 | I-29 | no | 70 | undecylenic acid | 96 | 15.3 |
| 466 | I-30 | yes | 150 | undecylenic acid | 105 | 3.2 |
| 467 | I-31 | yes | 210 | undecylenic acid | 104 | 3.2 |
| 468 | I-32 | no | 280 | undecylenic acid | 93 | 3.3 |

### Example 469: Production of Pigment Preparation J-1 (not in Accordance with the Invention)

An aqueous suspension of pigment J, as obtained after step c) of Example 10, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation J-1)

### Examples 470 to 500: Production of Pigment Preparations J-2 to J-32 (not in Accordance with the Invention and According to the Invention)

Analogously to Example 469, pigment preparations J-2 to J-32, according to the invention and not in accordance with the invention, were produced in Examples 469 to 500. In each case, an aqueous suspension of pigment J, as obtained after step c) of Example 10, was admixed with different aliphatic carboxylic acids B) or mixtures thereof in different amounts, as indicated in Table 2.

### Determination of Colour Strength and Filter Pressure Value

For the pigment preparations J-1 to J-32, the colour strength compared to pigment I and the filter pressure value were determined in accordance with protocols 1 and 2 below. The values can also be found in Table 12.

TABLE 12
Pigment preparations with pigment J

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 469 | J-1 | no | 70 | Pristerene ® 4910 | 95 | 15.6 |
| 470 | J-2 | yes | 120 | Pristerene ® 4910 | 106 | 3.0 |
| 471 | J-3 | yes | 210 | Pristerene ® 4910 | 106 | 3.0 |
| 472 | J-4 | no | 280 | Pristerene ® 4910 | 92 | 3.1 |
| 473 | J-5 | no | 150 | caprylic acid | 92 | 15.2 |
| 474 | J-6 | no | 210 | caprylic acid | 91 | 15.2 |
| 475 | J-7 | no | 150 | nervonic acid | 92 | 15.6 |
| 476 | J-8 | no | 210 | nervonic acid | 91 | 15.7 |
| 477 | J-9 | no | 70 | capric acid | 93 | 15.6 |
| 478 | J-10 | yes | 120 | capric acid | 105 | 3.3 |
| 479 | J-11 | yes | 250 | capric acid | 105 | 3.3 |
| 480 | J-12 | no | 280 | capric acid | 93 | 3.3 |
| 481 | J-13 | no | 70 | palmitic acid | 94 | 15.6 |
| 482 | J-14 | yes | 120 | palmitic acid | 106 | 3.0 |
| 483 | J-15 | yes | 210 | palmitic acid | 106 | 3.0 |
| 484 | J-16 | no | 280 | palmitic acid | 95 | 3.1 |
| 485 | J-17 | no | 70 | stearic acid | 95 | 15.7 |
| 486 | J-18 | yes | 150 | stearic acid | 106 | 3.1 |
| 487 | J-19 | yes | 210 | stearic acid | 105 | 3.1 |
| 488 | J-20 | no | 280 | stearic acid | 96 | 3.0 |
| 489 | J-21 | no | 70 | behenic acid | 96 | 15.9 |
| 490 | J-22 | yes | 100 | behenic acid | 105 | 3.3 |
| 491 | J-23 | yes | 210 | behenic acid | 105 | 3.3 |
| 492 | J-24 | no | 280 | behenic acid | 94 | 3.4 |
| 493 | J-25 | no | 70 | oleic acid | 93 | 15.8 |
| 494 | J-26 | yes | 120 | oleic acid | 104 | 3.3 |
| 495 | J-27 | yes | 210 | oleic acid | 104 | 3.4 |
| 496 | J-28 | no | 280 | oleic acid | 93 | 3.4 |
| 497 | J-29 | no | 70 | undecylenic acid | 94 | 16.1 |
| 498 | J-30 | yes | 120 | undecylenic acid | 105 | 3.4 |
| 499 | J-31 | yes | 210 | undecylenic acid | 105 | 3.3 |
| 500 | J-32 | no | 280 | undecylenic acid | 94 | 3.3 |

### Example 501: Production of Pigment Preparation K-1 (not in Accordance with the Invention)

An aqueous suspension of pigment K, as obtained after step c) of Example 11, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation K-1)

### Examples 502 to 532: Production of Pigment Preparations K-2 to K-32 (not in Accordance with the Invention and According to the Invention)

Analogously to Example 501, pigment preparations K-2 to K-32, according to the invention and not in accordance with the invention, were produced in Examples 502 to 532. In each case, an aqueous suspension of pigment K, as obtained after step c) of Example 11, was admixed with different aliphatic carboxylic acids B) or mixtures thereof in different amounts, as indicated in Table 13.

### Determination of Colour Strength and Filter Pressure Value

For pigment preparations K-1 to K-32, the colour strength compared to pigment K and the filter pressure value were determined in accordance with protocols 1 and 2 indicated below. The values can also be found in Table 13.

TABLE 13
Pigment preparations with pigment K

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 501 | K-1 | no | 70 | Pristerene ® 4910 | 95 | 15.6 |
| 502 | K-2 | yes | 120 | Pristerene ® 4910 | 106 | 3.0 |
| 503 | K-3 | yes | 210 | Pristerene ® 4910 | 106 | 3.0 |
| 504 | K-4 | no | 280 | Pristerene ® 4910 | 92 | 3.1 |
| 505 | K-5 | no | 150 | caprylic acid | 92 | 15.2 |
| 506 | K-6 | no | 210 | caprylic acid | 91 | 15.2 |
| 507 | K-7 | no | 150 | nervonic acid | 92 | 15.6 |
| 508 | K-8 | no | 210 | nervonic acid | 91 | 15.7 |
| 509 | K-9 | no | 70 | myristic acid | 93 | 15.6 |
| 510 | K-10 | yes | 120 | myristic acid | 105 | 3.3 |
| 511 | K-11 | yes | 250 | myristic acid | 105 | 3.3 |
| 512 | K-12 | no | 280 | myristic acid | 93 | 3.3 |
| 513 | K-13 | no | 70 | palmitic acid | 94 | 15.6 |
| 514 | K-14 | yes | 120 | palmitic acid | 106 | 3.0 |
| 515 | K-15 | yes | 210 | palmitic acid | 106 | 3.0 |
| 516 | K-16 | no | 280 | palmitic acid | 95 | 3.1 |
| 517 | K-17 | no | 70 | stearic acid | 95 | 15.7 |
| 518 | K-18 | yes | 150 | stearic acid | 106 | 3.1 |
| 519 | K-19 | yes | 210 | stearic acid | 105 | 3.1 |
| 520 | K-20 | no | 280 | stearic acid | 96 | 3.0 |
| 521 | K-21 | no | 70 | behenic acid | 96 | 15.9 |
| 522 | K-22 | yes | 100 | behenic acid | 105 | 3.3 |
| 523 | K-23 | yes | 210 | behenic acid | 105 | 3.3 |
| 524 | K-24 | no | 280 | behenic acid | 94 | 3.4 |
| 525 | K-25 | no | 70 | oleic acid | 93 | 15.8 |
| 526 | K-26 | yes | 120 | oleic acid | 104 | 3.3 |
| 527 | K-27 | yes | 210 | oleic acid | 104 | 3.4 |
| 528 | K-28 | no | 280 | oleic acid | 93 | 3.3 |
| 529 | K-29 | no | 70 | undecylenic acid | 94 | 16.0 |
| 530 | K-30 | yes | 120 | undecylenic acid | 105 | 3.4 |
| 531 | K-31 | yes | 210 | undecylenic acid | 105 | 3.4 |
| 532 | K-32 | no | 280 | undecylenic acid | 94 | 3.3 |

### Example 533: Production of Pigment Preparation L-1 (not in Accordance with the Invention)

An aqueous suspension of the pigment L, as obtained after step c) of Example 12, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation L-1)

### Examples 534 to 563: Production of Pigment Preparations L-2 to L-32 (not in Accordance with the Invention)

Similarly to Example 530, pigment preparations L-2 to L-32 not in accordance with the invention were produced in Examples 531 to 561. In each case, an aqueous suspension of the pigment L, as obtained after step c) of Example 12, was admixed with different aliphatic carboxylic acids B) or mixtures thereof in different amounts, as indicated in Table 14.

### Determination of Colour Strength and Filter Pressure Value

For pigment preparations L-1 to L-32, the colour strength compared to pigment L and the filter pressure value were determined in accordance with protocols 1 and 2 indicated below. The values can also be found in Table 14.

TABLE 14
Pigment preparations with pigment L

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 533 | L-1 | no | 70 | Pristerene ® 4910 | 94 | 15.6 |
| 534 | L-2 | no | 100 | Pristerene ® 4910 | 92 | 15.4 |
| 535 | L-3 | no | 210 | Pristerene ® 4910 | 91 | 15.6 |
| 536 | L-4 | no | 280 | Pristerene ® 4910 | 90 | 15.6 |
| 537 | L-5 | no | 70 | caprylic acid | 94 | 16.1 |
| 538 | L-6 | no | 250 | caprylic acid | 92 | 15.8 |
| 539 | L-7 | no | 70 | nervonic acid | 94 | 15.4 |
| 540 | L-8 | no | 250 | nervonic acid | 93 | 15.6 |
| 541 | L-9 | no | 70 | myristic acid | 94 | 15.6 |
| 542 | L-10 | no | 100 | myristic acid | 92 | 15.3 |
| 543 | L-11 | no | 150 | myristic acid | 90 | 15.1 |
| 544 | L-12 | no | 280 | myristic acid | 90 | 15.3 |
| 545 | L-13 | no | 100 | palmitic acid | 94 | 15.5 |
| 546 | L-14 | no | 150 | palmitic acid | 92 | 15.6 |
| 547 | L-15 | no | 210 | palmitic acid | 91 | 15.1 |
| 548 | L-16 | no | 280 | palmitic acid | 90 | 15.9 |
| 549 | L-17 | no | 70 | stearic acid | 94 | 15.8 |
| 550 | L-18 | no | 100 | stearic acid | 91 | 15.6 |
| 551 | L-19 | no | 210 | stearic acid | 90 | 15.6 |
| 552 | L-20 | no | 280 | stearic acid | 89 | 15.8 |
| 553 | L-21 | no | 100 | behenic acid | 93 | 15.4 |
| 554 | L-22 | no | 150 | behenic acid | 90 | 15.3 |
| 555 | L-23 | no | 210 | behenic acid | 90 | 15.2 |
| 556 | L-24 | no | 250 | behenic acid | 89 | 15.2 |
| 557 | L-25 | no | 100 | oleic acid | 94 | 16.1 |
| 558 | L-26 | no | 150 | oleic acid | 92 | 15.2 |
| 559 | L-27 | no | 210 | oleic acid | 90 | 15.4 |
| 560 | L-28 | no | 280 | oleic acid | 90 | 15.6 |
| 561 | L-29 | no | 50 | undecylenic acid | 93 | 15.6 |
| 562 | L-30 | no | 100 | undecylenic acid | 92 | 15.8 |
| 563 | L-31 | no | 210 | undecylenic acid | 92 | 15.2 |
| 564 | L-32 | no | 235 | undecylenic acid | 90 | 15.4 |

### Example 565: Production of Pigment Preparation M-1 (not in Accordance with the Invention)

An aqueous suspension of pigment M, as obtained after step b) of Example 13, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation M-1)

### Examples 566 to 593: Production of Pigment Preparations M-2 to M-32 (not in Accordance with the Invention)

Analogously to Example 565, pigment preparations M-2 to M-32, according to the invention and not in accordance with the invention, were produced in Examples 563 to 593. In each case, an aqueous suspension of the pigment M, as obtained after step b) of Example 13, was admixed with different aliphatic carboxylic acids B) or mixtures thereof in different amounts, as indicated in Table 15.

### Determination of Colour Strength and Filter Pressure Value

For pigment preparations M-1 to M-32, the colour strength compared to pigment M and the filter pressure value were determined in accordance with protocols 1 and 2 indicated below. The values can also be found in Table 15

TABLE 15
Pigment preparations with pigment M

| | | | Grams of aliphatic | | | |
|---|---|---|---|---|---|---|
| | | | carboxylic acid | Aliphatic | | |
| | | According | B) or mixture | carboxylic | Colour | |
| | Pigment | to the | per mole of | acid B) | strength | FPV |
| Example | preparation | invention | pigment | or mixture | [%] | [bar/g] |
| 565 | M-1 | no | 70 | Pristerene ® 4910 | 94 | 15.6 |
| 566 | M-2 | no | 100 | Pristerene ® 4910 | 92 | 15.4 |
| 567 | M-3 | no | 210 | Pristerene ® 4910 | 91 | 15.6 |
| 568 | M-4 | no | 280 | Pristerene ® 4910 | 90 | 15.8 |
| 569 | M-5 | no | 70 | caprylic acid | 94 | 16.1 |
| 570 | M-6 | no | 210 | caprylic acid | 92 | 15.8 |
| 571 | M-7 | no | 70 | nervonic acid | 94 | 15.4 |
| 572 | M-8 | no | 210 | nervonic acid | 93 | 15.6 |
| 573 | M-9 | no | 70 | myristic acid | 94 | 15.6 |
| 574 | M-10 | no | 100 | myristic acid | 92 | 15.3 |
| 575 | M-11 | no | 150 | myristic acid | 90 | 15.3 |
| 576 | M-12 | no | 280 | myristic acid | 90 | 15.3 |
| 577 | M-13 | no | 70 | palmitic acid | 95 | 15.5 |
| 578 | M-14 | no | 150 | palmitic acid | 92 | 15.6 |
| 579 | M-15 | no | 210 | palmitic acid | 91 | 15.1 |
| 580 | M-16 | no | 235 | palmitic acid | 90 | 15.9 |
| 581 | M-17 | no | 70 | stearic acid | 94 | 15.8 |
| 582 | M-18 | no | 100 | stearic acid | 91 | 15.6 |
| 583 | M-19 | no | 210 | stearic acid | 90 | 15.6 |
| 584 | M-20 | no | 235 | stearic acid | 89 | 15.8 |
| 585 | M-21 | no | 70 | behenic acid | 93 | 15.4 |
| 586 | M-22 | no | 150 | behenic acid | 91 | 15.3 |
| 587 | M-23 | no | 210 | behenic acid | 90 | 15.2 |
| 588 | M-24 | no | 280 | behenic acid | 90 | 15.2 |
| 589 | M-25 | no | 70 | oleic acid | 94 | 16.1 |
| 590 | M-26 | no | 150 | oleic acid | 92 | 15.2 |
| 591 | M-27 | no | 210 | oleic acid | 90 | 15.4 |
| 592 | M-28 | no | 280 | oleic acid | 90 | 15.6 |
| 593 | M-29 | no | 70 | undecylenic acid | 93 | 15.6 |
| 591 | M-30 | no | 100 | undecylenic acid | 92 | 15.8 |
| 592 | M-31 | no | 210 | undecylenic acid | 92 | 15.4 |
| 593 | M-32 | no | 280 | undecylenic acid | 90 | 15.8 |

### Example 594: Production of Pigment Preparation N-1 (not in Accordance with the Invention)

An aqueous suspension of pigment N, as obtained after step b) of Example 14, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation N-1)

### Examples 595 to 597: Production of Pigment Preparations N-2 to N-32 (not in Accordance with the Invention)

Analogously to Example 594, pigment preparations N-2 to N-32, according to the invention and not in accordance with the invention, were produced in Examples 595 to 625. In each case, an aqueous suspension of the pigment N, as obtained after step b) of Example 14, was admixed with different aliphatic carboxylic acids B) or mixtures thereof in different amounts, as indicated in Table 16.

### Determination of Colour Strength and Filter Pressure Value

For pigment preparations N-1 to N-32, the colour strength compared to pigment N and the filter pressure value were determined according to protocols 1 and 2 indicated below. The values can also be found in Table 16.

TABLE 16
Pigment preparations with pigment N

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 594 | N-1 | no | 70 | Pristerene® 4910 | 94 | 15.6 |
| 595 | N-2 | no | 100 | Pristerene® 4910 | 92 | 15.4 |
| 596 | N-3 | no | 210 | Pristerene® 4910 | 91 | 15.6 |
| 597 | N-4 | no | 280 | Pristerene® 4910 | 90 | 15.8 |
| 598 | N-5 | no | 70 | caprylic acid | 94 | 16.1 |
| 599 | N-6 | no | 210 | caprylic acid | 92 | 15.8 |
| 600 | N-7 | no | 70 | nervonic acid | 94 | 15.4 |
| 601 | N-8 | no | 210 | nervonic acid | 93 | 15.6 |
| 602 | N-9 | no | 70 | myristic acid | 94 | 15.6 |
| 603 | N-10 | no | 120 | myristic acid | 92 | 15.3 |
| 604 | N-11 | no | 150 | myristic acid | 90 | 15.3 |
| 605 | N-12 | no | 280 | myristic acid | 90 | 15.3 |
| 606 | N-13 | no | 70 | palmitic acid | 95 | 15.5 |
| 607 | N-14 | no | 150 | palmitic acid | 92 | 15.6 |
| 608 | N-15 | no | 210 | palmitic acid | 91 | 15.8 |
| 609 | N-16 | no | 250 | palmitic acid | 90 | 15.9 |
| 610 | N-17 | no | 50 | stearic acid | 94 | 15.8 |
| 611 | N-18 | no | 100 | stearic acid | 91 | 15.6 |
| 612 | N-19 | no | 210 | stearic acid | 90 | 15.6 |
| 613 | N-20 | no | 280 | stearic acid | 89 | 15.8 |
| 614 | N-21 | no | 70 | behenic acid | 93 | 15.4 |
| 615 | N-22 | no | 150 | behenic acid | 91 | 15.3 |
| 616 | N-23 | no | 210 | behenic acid | 90 | 15.2 |
| 617 | N-24 | no | 280 | behenic acid | 90 | 15.2 |
| 618 | N-25 | no | 70 | oleic acid | 94 | 16.1 |
| 619 | N-26 | no | 150 | oleic acid | 92 | 15.2 |
| 620 | N-27 | no | 210 | oleic acid | 90 | 15.4 |
| 621 | N-28 | no | 250 | oleic acid | 90 | 15.2 |
| 622 | N-29 | no | 70 | undecylenic acid | 93 | 15.6 |
| 623 | N-30 | no | 100 | undecylenic acid | 92 | 15.8 |
| 624 | N-31 | no | 210 | undecylenic acid | 92 | 15.4 |
| 625 | N-32 | no | 280 | undecylenic acid | 90 | 15.8 |

### Example 626: Production of Pigment Preparation O-1 (not in Accordance with the Invention)

An aqueous suspension of pigment O, as obtained after step b) of Example 11, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation O-1)

### Examples 627 to 657: Production of Pigment Preparations O-2 to 0-32 (not in Accordance with the Invention)

Analogously to Example 626, pigment preparations O-2 to O-32, according to the invention and not in accordance with the invention, were produced in Examples 627 to 657. In each case, an aqueous suspension of the pigment O, as obtained after step b) of Example 15, was admixed with different aliphatic carboxylic acids B) or mixtures thereof in different amounts, as indicated in Table 17.

### Determination of Colour Strength and Filter Pressure Value

For pigment preparations O-1 to O-32, the colour strength compared to pigment O and the filter pressure value were determined in accordance with protocols 1 and 2 indicated below. The values can also be found in Table 17.

TABLE 17
Pigment preparations with pigment O

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 626 | O-1 | no | 70 | Pristerene® 4910 | 94 | 15.6 |
| 627 | O-2 | no | 100 | Pristerene® 4910 | 92 | 15.4 |
| 628 | O-3 | no | 210 | Pristerene® 4910 | 90 | 15.6 |
| 629 | O-4 | no | 250 | Pristerene® 4910 | 90 | 15.6 |
| 630 | O-5 | no | 70 | caprylic acid | 94 | 16.1 |
| 631 | O-6 | no | 210 | caprylic acid | 92 | 15.8 |
| 632 | O-7 | no | 70 | nervonic acid | 94 | 15.4 |
| 633 | O-8 | no | 210 | nervonic acid | 92 | 15.6 |
| 634 | O-9 | no | 70 | myristic acid | 94 | 15.6 |
| 635 | O-10 | no | 120 | myristic acid | 92 | 15.3 |
| 636 | O-11 | no | 180 | myristic acid | 91 | 15.1 |
| 637 | O-12 | no | 250 | myristic acid | 90 | 15.3 |
| 638 | O-13 | no | 120 | palmitic acid | 94 | 15.5 |
| 639 | O-14 | no | 150 | palmitic acid | 92 | 15.6 |
| 640 | O-15 | no | 210 | palmitic acid | 91 | 15.1 |
| 641 | O-16 | no | 250 | palmitic acid | 90 | 15.9 |
| 642 | O-17 | no | 70 | stearic acid | 94 | 15.8 |
| 643 | O-18 | no | 100 | stearic acid | 91 | 15.4 |
| 644 | O-19 | no | 210 | stearic acid | 91 | 15.6 |
| 645 | O-20 | no | 280 | stearic acid | 90 | 15.8 |
| 646 | O-21 | no | 70 | behenic acid | 93 | 15.4 |
| 647 | O-22 | no | 150 | behenic acid | 90 | 15.3 |
| 648 | O-23 | no | 210 | behenic acid | 90 | 15.2 |
| 649 | O-24 | no | 250 | behenic acid | 89 | 15.6 |
| 650 | O-25 | no | 70 | oleic acid | 94 | 16.1 |
| 651 | O-26 | no | 120 | oleic acid | 92 | 15.2 |
| 652 | O-27 | no | 210 | oleic acid | 90 | 15.4 |
| 653 | O-28 | no | 280 | oleic acid | 90 | 15.8 |
| 654 | O-29 | no | 70 | undecylenic acid | 93 | 15.6 |
| 655 | O-30 | no | 100 | undecylenic acid | 92 | 15.8 |
| 656 | O-31 | no | 250 | undecylenic acid | 92 | 15.4 |
| 657 | O-32 | no | 280 | undecylenic acid | 90 | 15.4 |

### Example 658: Production of Pigment Preparation P-1 (not in Accordance with the Invention)

An aqueous suspension of pigment P, as obtained after step b) of Example 16, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation P-1)

### Examples 659 to 689: Production of Pigment Preparations P-2 to P-32 (not in Accordance with the Invention and According to the Invention)

Analogously to Example 658, pigment preparations P-2 to P-32, according to the invention and not in accordance with the invention, were produced in Examples 659 to 689. In each case, an aqueous suspension of the pigment P, as obtained after step b) of Example 16, was admixed with different aliphatic carboxylic acids B) or mixtures thereof in different amounts, as indicated in Table 18.

### Determination of Colour Strength and Filter Pressure Value

For pigment preparations P-1 to P-32, the colour strength compared to pigment P and the filter pressure value were determined in accordance with protocols 1 and 2 indicated below. The values can also be found in Table 18.

TABLE 18
Pigment preparations with pigment P

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 658 | P-1 | no | 70 | Pristerene ® 4910 | 96 | 15.8 |
| 659 | P-2 | yes | 100 | Pristerene ® 4910 | 114 | 2.9 |
| 660 | P-3 | yes | 210 | Pristerene ® 4910 | 114 | 2.9 |
| 661 | P-4 | no | 280 | Pristerene ® 4910 | 111 | 3.0 |
| 662 | P-5 | no | 70 | caprylic acid | 95 | 15.5 |
| 663 | P-6 | no | 210 | caprylic acid | 95 | 15.6 |
| 664 | P-7 | no | 70 | nervonic acid | 90 | 15.8 |
| 665 | P-8 | no | 280 | nervonic acid | 87 | 15.6 |
| 666 | P-9 | no | 70 | myristic acid | 95 | 15.2 |
| 667 | P-10 | yes | 100 | myristic acid | 112 | 3.4 |
| 668 | P-11 | yes | 150 | myristic acid | 112 | 3.3 |
| 669 | P-12 | no | 280 | myristic acid | 95 | 3.3 |
| 670 | P-13 | no | 70 | palmitic acid | 95 | 15.5 |
| 671 | P-14 | yes | 150 | palmitic acid | 113 | 3.0 |
| 672 | P-15 | yes | 210 | palmitic acid | 113 | 3.1 |
| 673 | P-16 | no | 280 | palmitic acid | 94 | 3.2 |
| 674 | P-17 | no | 70 | stearic acid | 94 | 15.2 |
| 675 | P-18 | yes | 100 | stearic acid | 112 | 3.0 |
| 676 | P-19 | yes | 210 | stearic acid | 113 | 3.0 |
| 677 | P-20 | no | 280 | stearic acid | 96 | 3.1 |
| 678 | P-21 | no | 70 | behenic acid | 95 | 15.6 |
| 679 | P-22 | yes | 150 | behenic acid | 111 | 3.2 |
| 680 | P-23 | yes | 210 | behenic acid | 110 | 3.2 |
| 681 | P-24 | no | 280 | behenic acid | 91 | 3.3 |
| 682 | P-25 | no | 70 | oleic acid | 96 | 15.6 |
| 683 | P-26 | yes | 100 | oleic acid | 110 | 3.3 |
| 684 | P-27 | yes | 210 | oleic acid | 112 | 3.3 |
| 685 | P-28 | no | 280 | oleic acid | 96 | 3.3 |
| 686 | P-29 | no | 50 | undecylenic acid | 95 | 15.9 |
| 687 | P-30 | yes | 100 | undecylenic acid | 111 | 3.2 |
| 688 | P-31 | yes | 235 | undecylenic acid | 112 | 3.2 |
| 689 | P-32 | no | 280 | undecylenic acid | 92 | 3.3 |

### Example 690: Production of Pigment Preparation Q-1 (not in Accordance with the Invention)

An aqueous suspension of pigment Q, as obtained after step b) of Example 17, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation Q-1)

### Examples 691 to 721: Production of Pigment Preparations Q-2 to Q-32 (not in Accordance with the Invention and According to the Invention)

Analogously to Example 690, pigment preparations Q-2 to Q-32, according to the invention and not in accordance with the invention, were produced in Examples 691 to 721. In each case, an aqueous suspension of the pigment Q, as obtained after step b) of Example 17, was admixed with different aliphatic carboxylic acids B) or mixtures thereof in different amounts, as indicated in Table 19.

### Determination of Colour Strength and Filter Pressure Value

For the pigment preparations Q-1 to Q-32, the colour strength compared to pigment Q and the filter pressure value were determined in accordance with protocols 1 and 2 indicated below. The values can also be found in Table 19.

TABLE 19
Pigment preparations with pigment Q

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 690 | Q-1 | no | 70 | Pristerene ® 4910 | 96 | 15.1 |
| 691 | Q-2 | yes | 120 | Pristerene ® 4910 | 119 | 3.1 |
| 692 | Q-3 | yes | 250 | Pristerene ® 4910 | 118 | 3.2 |
| 693 | Q-4 | no | 280 | Pristerene ® 4910 | 95 | 3.2 |
| 694 | Q-5 | no | 70 | caprylic acid | 95 | 15.6 |
| 695 | Q-6 | no | 210 | caprylic acid | 92 | 15.5 |
| 696 | Q-7 | no | 100 | nervonic acid | 96 | 15.4 |
| 697 | Q-8 | no | 210 | nervonic acid | 91 | 15.1 |
| 698 | Q-9 | no | 70 | myristic acid | 95 | 15.2 |
| 699 | Q-10 | yes | 120 | myristic acid | 116 | 3.1 |
| 700 | Q-11 | yes | 210 | myristic acid | 116 | 3.2 |
| 701 | Q-12 | no | 280 | myristic acid | 96 | 3.2 |
| 702 | Q-13 | no | 70 | palmitic acid | 95 | 15.6 |
| 703 | Q-14 | yes | 150 | palmitic acid | 119 | 3.0 |
| 704 | Q-15 | yes | 250 | palmitic acid | 119 | 3.0 |
| 705 | Q-16 | no | 280 | palmitic acid | 96 | 3.0 |
| 706 | Q-17 | no | 70 | stearic acid | 95 | 15.5 |
| 707 | Q-18 | yes | 120 | stearic acid | 119 | 3.1 |
| 708 | Q-19 | yes | 180 | stearic acid | 118 | 3.1 |
| 709 | Q-20 | no | 280 | stearic acid | 96 | 3.2 |
| 710 | Q-21 | no | 70 | behenic acid | 94 | 15.9 |
| 711 | Q-22 | yes | 180 | behenic acid | 115 | 3.3 |
| 712 | Q-23 | yes | 250 | behenic acid | 114 | 3.3 |
| 713 | Q-24 | no | 280 | behenic acid | 95 | 3.3 |
| 714 | Q-25 | no | 70 | oleic acid | 95 | 15.7 |
| 715 | Q-26 | yes | 100 | oleic acid | 115 | 3.2 |
| 716 | Q-27 | yes | 210 | oleic acid | 114 | 3.3 |
| 717 | Q-28 | no | 280 | oleic acid | 96 | 3.3 |
| 718 | Q-29 | no | 70 | undecylenic acid | 95 | 16.1 |
| 719 | Q-30 | yes | 120 | undecylenic acid | 113 | 3.3 |
| 720 | Q-31 | yes | 250 | undecylenic acid | 112 | 3.4 |
| 721 | Q-32 | no | 280 | undecylenic acid | 94 | 3.4 |

### Example 722: Production of Pigment Preparation R-1 (not in Accordance with the Invention)

An aqueous suspension of pigment R, as obtained after step b) of Example 18, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation R-1)

### Examples 723 to 753: Production of Pigment Preparations R-2 to R-32 (not in Accordance with the Invention and According to the Invention)

Analogously to Example 722, pigment preparations R-2 to R-32, according to the invention and not in accordance with the invention, were produced in Examples 723 to 753. In each case, an aqueous suspension of the pigment R, as obtained after step b) of Example 18, was admixed with different aliphatic carboxylic acids B) or mixtures thereof in different amounts, as indicated in Table 20.

### Determination of Colour Strength and Filter Pressure Value

For pigment preparations R-1 to R-32, the colour strength compared to pigment R and the filter pressure value were determined in accordance with protocols 1 and 2 indicated below. The values can also be found in Table 20.

TABLE 20
Pigment preparations with pigment R

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 722 | R-1 | no | 70 | Pristerene ® 4910 | 94 | 15.2 |
| 723 | R-2 | yes | 120 | Pristerene ® 4910 | 119 | 3.0 |
| 724 | R-3 | yes | 250 | Pristerene ® 4910 | 118 | 3.0 |
| 725 | R-4 | no | 280 | Pristerene ® 4910 | 96 | 3.1 |
| 726 | R-5 | no | 70 | caprylic acid | 95 | 15.6 |
| 727 | R-6 | no | 210 | caprylic acid | 96 | 15.2 |
| 728 | R-7 | no | 100 | nervonic acid | 94 | 16.1 |
| 729 | R-8 | no | 210 | nervonic acid | 95 | 15.9 |
| 730 | R-9 | no | 70 | myristic acid | 95 | 15.1 |
| 731 | R-10 | yes | 120 | myristic acid | 116 | 3.4 |
| 732 | R-11 | yes | 210 | myristic acid | 116 | 3.4 |
| 733 | R-12 | no | 280 | myristic acid | 94 | 3.3 |
| 734 | R-13 | no | 70 | palmitic acid | 95 | 16.1 |
| 735 | R-14 | yes | 150 | palmitic acid | 116 | 3.2 |
| 736 | R-15 | yes | 250 | palmitic acid | 118 | 3.2 |
| 737 | R-16 | no | 280 | palmitic acid | 94 | 3.3 |
| 738 | R-17 | no | 70 | stearic acid | 95 | 15.9 |
| 739 | R-18 | yes | 120 | stearic acid | 119 | 3.1 |
| 740 | R-19 | yes | 180 | stearic acid | 118 | 3.1 |
| 741 | R-20 | no | 280 | stearic acid | 95 | 3.2 |
| 742 | R-21 | no | 70 | behenic acid | 95 | 16.3 |
| 743 | R-22 | yes | 180 | behenic acid | 116 | 3.4 |
| 744 | R-23 | yes | 250 | behenic acid | 115 | 3.4 |
| 745 | R-24 | no | 280 | behenic acid | 95 | 3.5 |
| 746 | R-25 | no | 70 | oleic acid | 94 | 16.5 |
| 747 | R-26 | yes | 100 | oleic acid | 114 | 3.5 |
| 748 | R-27 | yes | 210 | oleic acid | 114 | 3.5 |
| 749 | R-28 | no | 280 | oleic acid | 95 | 3.4 |
| 750 | R-29 | no | 70 | undecylenic acid | 96 | 15.9 |
| 751 | R-30 | yes | 120 | undecylenic acid | 114 | 3.4 |
| 752 | R-31 | yes | 250 | undecylenic acid | 114 | 3.4 |
| 753 | R-32 | no | 280 | undecylenic acid | 95 | 3.4 |

### Example 754: Production of Pigment Preparation S-1 (not in Accordance with the Invention)

An aqueous suspension of the pigment S, as obtained after step b) of Example 19, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation S-1)

### Examples 754 to 784: Production of Pigment Preparations S-2 to S-32 (not in Accordance with the Invention and According to the Invention)

Analogously to Example 727, pigment preparations S-2 to S-32, according to the invention and not in accordance with the invention, were produced in Examples 754 to 784. In each case, an aqueous suspension of the pigment S, as obtained after step b) of Example 19, was admixed with different aliphatic carboxylic acids B) or mixtures thereof in different amounts, as indicated in Table 21.

### Determination of Colour Strength and Filter Pressure Value

For pigment preparations S-1 to S-32, the colour strength compared to pigment S and the filter pressure value were determined in accordance with protocols 1 and 2 indicated below. The values can also be found in Table 21.

TABLE 21
Pigment preparations with pigment S

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 754 | S-1 | no | 70 | Pristerene ® 4910 | 94 | 15.6 |
| 755 | S-2 | yes | 120 | Pristerene ® 4910 | 117 | 3.2 |
| 756 | S-3 | yes | 250 | Pristerene ® 4910 | 118 | 3.1 |
| 757 | S-4 | no | 280 | Pristerene ® 4910 | 95 | 3.1 |
| 758 | S-5 | no | 70 | caprylic acid | 94 | 16.1 |
| 759 | S-6 | no | 210 | caprylic acid | 95 | 16.2 |
| 760 | S-7 | no | 100 | nervonic acid | 95 | 15.9 |
| 761 | S-8 | no | 210 | nervonic acid | 93 | 15.8 |
| 762 | S-9 | no | 70 | myristic acid | 96 | 15.8 |
| 763 | S-10 | yes | 120 | myristic acid | 114 | 3.3 |
| 764 | S-11 | yes | 210 | myristic acid | 114 | 3.4 |
| 765 | S-12 | no | 280 | myristic acid | 96 | 3.4 |
| 766 | S-13 | no | 70 | palmitic acid | 95 | 15.7 |
| 767 | S-14 | yes | 150 | palmitic acid | 117 | 3.3 |
| 768 | S-15 | yes | 250 | palmitic acid | 116 | 3.3 |
| 769 | S-16 | no | 280 | palmitic acid | 95 | 3.4 |
| 770 | S-17 | no | 70 | stearic acid | 96 | 15.8 |
| 771 | S-18 | yes | 120 | stearic acid | 118 | 3.2 |
| 772 | S-19 | yes | 180 | stearic acid | 117 | 3.2 |
| 773 | S-20 | no | 280 | stearic acid | 95 | 3.2 |
| 774 | S-21 | no | 70 | behenic acid | 94 | 3.2 |
| 775 | S-22 | yes | 180 | behenic acid | 115 | 15.8 |
| 776 | S-23 | yes | 250 | behenic acid | 114 | 3.4 |
| 777 | S-24 | no | 280 | behenic acid | 93 | 3.4 |
| 778 | S-25 | no | 70 | oleic acid | 95 | 15.8 |
| 779 | S-26 | yes | 100 | oleic acid | 113 | 3.3 |
| 780 | S-27 | yes | 210 | oleic acid | 114 | 3.4 |
| 781 | S-28 | no | 280 | oleic acid | 94 | 3.4 |
| 782 | S-29 | no | 70 | undecylenic acid | 95 | 15.6 |
| 783 | S-30 | yes | 120 | undecylenic acid | 112 | 3.2 |
| 784 | S-31 | yes | 250 | undecylenic acid | 113 | 3.2 |
| 784 | S-32 | no | 280 | undecylenic acid | 94 | 3.2 |

### Example 785: Production of Pigment Preparation T-1 (not in Accordance with the Invention)

An aqueous suspension of pigment T, as obtained after step b) of Example 20, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation T-1)

### Examples 786 to 816: Production of Pigment Preparations T-2 to T-32 (not in Accordance with the Invention and According to the Invention)

Analogously to Example 785, pigment preparations T-2 to T-32, according to the invention and not in accordance with the invention, were produced in Examples 785 to 816. In each case, an aqueous suspension of the pigment T, as obtained after step b) of Example 20, was admixed with different aliphatic carboxylic acids B) or mixtures thereof in different amounts, as indicated in Table 22.

### Determination of Colour Strength and Filter Pressure Value

For pigment preparations T-1 to T-32, the colour strength compared to pigment T and the filter pressure value were determined in accordance with protocols 1 and 2 indicated below. The values can also be found in Table 22.

TABLE 22
Pigment preparations with pigment T

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 785 | T-1 | no | 70 | Pristerene ® 4910 | 94 | 16.1 |
| 786 | T-2 | yes | 100 | Pristerene ® 4910 | 118 | 3.0 |
| 787 | T-3 | yes | 210 | Pristerene ® 4910 | 118 | 2.9 |
| 788 | T-4 | no | 280 | Pristerene ® 4910 | 93 | 3.0 |
| 789 | T-5 | no | 70 | caprylic acid | 94 | 16.3 |
| 790 | T-6 | no | 210 | caprylic acid | 113 | 16.2 |
| 791 | T-7 | no | 70 | nervonic acid | 113 | 16.4 |
| 792 | T-8 | no | 280 | nervonic acid | 94 | 16.3 |
| 793 | T-9 | no | 70 | myristic acid | 95 | 15.8 |
| 794 | T-10 | yes | 120 | myristic acid | 113 | 3.4 |
| 795 | T-11 | yes | 150 | myristic acid | 114 | 3.4 |
| 796 | T-12 | no | 280 | myristic acid | 95 | 3.5 |
| 797 | T-13 | no | 70 | palmitic acid | 96 | 15.7 |
| 798 | T-14 | yes | 150 | palmitic acid | 119 | 3.1 |
| 799 | T-15 | yes | 250 | palmitic acid | 118 | 3.1 |
| 800 | T-16 | no | 280 | palmitic acid | 96 | 3.1 |
| 801 | T-17 | no | 70 | stearic acid | 95 | 15.5 |
| 802 | T-18 | yes | 150 | stearic acid | 117 | 3.0 |
| 803 | T-19 | yes | 250 | stearic acid | 118 | 3.0 |
| 804 | T-20 | no | 280 | stearic acid | 94 | 3.1 |
| 805 | T-21 | no | 70 | behenic acid | 93 | 16.3 |
| 806 | T-22 | yes | 150 | behenic acid | 115 | 3.4 |
| 807 | T-23 | yes | 210 | behenic acid | 114 | 3.4 |
| 808 | T-24 | no | 280 | behenic acid | 113 | 3.5 |
| 809 | T-25 | no | 70 | oleic acid | 96 | 16.3 |
| 810 | T-26 | yes | 120 | oleic acid | 113 | 3.3 |
| 811 | T-27 | yes | 180 | oleic acid | 113 | 3.3 |
| 812 | T-28 | no | 280 | oleic acid | 92 | 3.3 |
| 813 | T-29 | no | 70 | undecylenic acid | 94 | 15.9 |
| 814 | T-30 | yes | 100 | undecylenic acid | 113 | 3.4 |
| 815 | T-31 | yes | 250 | undecylenic acid | 113 | 3.4 |
| 816 | T-32 | no | 280 | undecylenic acid | 95 | 3.4 |

### Example 817: Production of Pigment Preparation U-1 (not in Accordance with the Invention)

An aqueous suspension of pigment U, as obtained after step b) of Example 21, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation U-1)

### Examples 817 to 848: Production of Pigment Preparations U-2 to U-32 (not in Accordance with the Invention and According to the Invention)

Analogously to Example 793, pigment preparations U-2 to U-32, according to the invention and not in accordance with the invention, were produced in Examples 817 to 848. In each case, an aqueous suspension of the pigment U, as obtained after step b) of Example 21, was admixed with different aliphatic carboxylic acids B) or mixtures thereof in different amounts, as indicated in Table 23.

### Determination of Colour Strength and Filter Pressure Value

For pigment preparations U-1 to U-32, the colour strength compared to pigment U and the filter pressure value were determined in accordance with protocols 1 and 2 indicated below. The values can also be found in Table 23.

TABLE 23
Pigment preparations with pigment U

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 817 | U-1 | no | 70 | Pristerene ® 4910 | 95 | 15.6 |
| 818 | U-2 | yes | 180 | Pristerene ® 4910 | 112 | 3.1 |
| 819 | U-3 | yes | 250 | Pristerene ® 4910 | 112 | 3.1 |
| 820 | U-4 | no | 280 | Pristerene ® 4910 | 95 | 3.2 |
| 821 | U-5 | no | 70 | caprylic acid | 94 | 15.6 |
| 822 | U-6 | no | 210 | caprylic acid | 93 | 15.8 |
| 823 | U-7 | no | 70 | nervonic acid | 95 | 16.1 |
| 824 | U-8 | no | 250 | nervonic acid | 95 | 16.0 |
| 825 | U-9 | no | 70 | myristic acid | 95 | 15.9 |
| 826 | U-10 | yes | 120 | myristic acid | 115 | 3.3 |
| 827 | U-11 | yes | 180 | myristic acid | 115 | 3.3 |
| 828 | U-12 | no | 280 | myristic acid | 95 | 3.4 |
| 829 | U-13 | no | 70 | palmitic acid | 96 | 15.6 |
| 830 | U-14 | yes | 150 | palmitic acid | 118 | 3.2 |
| 831 | U-15 | yes | 210 | palmitic acid | 118 | 3.2 |
| 832 | U-16 | no | 280 | palmitic acid | 95 | 3.2 |
| 833 | U-17 | no | 70 | stearic acid | 96 | 15.6 |
| 834 | U-18 | yes | 150 | stearic acid | 116 | 3.1 |
| 835 | U-19 | yes | 250 | stearic acid | 95 | 3.2 |
| 836 | U-20 | no | 280 | stearic acid | 90 | 3.2 |
| 837 | U-21 | no | 70 | behenic acid | 96 | 15.3 |
| 838 | U-22 | yes | 120 | behenic acid | 113 | 3.4 |
| 839 | U-23 | yes | 210 | behenic acid | 114 | 3.4 |
| 840 | U-24 | no | 280 | behenic acid | 95 | 3.4 |
| 841 | U-25 | no | 70 | oleic acid | 95 | 15.6 |
| 842 | U-26 | yes | 120 | oleic acid | 112 | 3.3 |
| 843 | U-27 | yes | 210 | oleic acid | 111 | 3.2 |
| 844 | U-28 | no | 280 | oleic acid | 96 | 3.2 |
| 845 | U-29 | no | 70 | undecylenic acid | 96 | 15.9 |
| 846 | U-30 | yes | 150 | undecylenic acid | 113 | 3.4 |
| 847 | U-31 | yes | 250 | undecylenic acid | 113 | 3.4 |
| 848 | U-32 | no | 280 | undecylenic acid | 95 | 3.3 |

### Example 849: Production of Pigment Preparation V-1 (not in Accordance with the Invention)

An aqueous suspension of pigment U, as obtained after step b) of Example 22, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation V-1)

### Examples 850 to 880: Production of Pigment Preparations V-2 to V-32 (not in Accordance with the Invention and According to the Invention)

Analogously to Example 849, pigment preparations V-2 to V-32, according to the invention and not in accordance with the invention, were produced in Examples 850 to 880. In each case, an aqueous suspension of the pigment V, as obtained after step b) of Example 22, was admixed with different aliphatic carboxylic acids B) or mixtures thereof in different amounts, as indicated in Table 24.

### Determination of Colour Strength and Filter Pressure Value

For pigment preparations V-1 to V-32, the colour strength compared to pigment V and the filter pressure value were determined in accordance with protocols 1 and 2 indicated below. The values can also be found in Table 24.

TABLE 24
Pigment preparations with pigment V

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 849 | V-1 | no | 70 | Pristerene ® 4910 | 94 | 15.8 |
| 850 | V-2 | yes | 180 | Pristerene ® 4910 | 117 | 3.0 |
| 851 | V-3 | yes | 250 | Pristerene ® 4910 | 117 | 2.9 |
| 852 | V-4 | no | 280 | Pristerene ® 4910 | 96 | 3.0 |
| 853 | V-5 | no | 70 | caprylic acid | 96 | 15.6 |
| 854 | V-6 | no | 210 | caprylic acid | 95 | 16.1 |
| 855 | V-7 | no | 70 | nervonic acid | 95 | 16.2 |
| 856 | V-8 | no | 250 | nervonic acid | 93 | 16.5 |
| 857 | V-9 | no | 70 | myristic acid | 95 | 15.9 |
| 858 | V-10 | yes | 120 | myristic acid | 115 | 3.4 |
| 859 | V-11 | yes | 180 | myristic acid | 115 | 3.4 |
| 860 | V-12 | no | 280 | myristic acid | 96 | 3.4 |
| 861 | V-13 | no | 70 | palmitic acid | 95 | 15.6 |
| 862 | V-14 | yes | 150 | palmitic acid | 116 | 3.1 |
| 863 | V-15 | yes | 210 | palmitic acid | 116 | 3.1 |
| 864 | V-16 | no | 280 | palmitic acid | 95 | 3.1 |
| 865 | V-17 | no | 70 | stearic acid | 96 | 15.9 |
| 866 | V-18 | yes | 150 | stearic acid | 116 | 3.0 |
| 867 | V-19 | yes | 250 | stearic acid | 116 | 3.0 |
| 868 | V-20 | no | 280 | stearic acid | 95 | 3.0 |
| 869 | V-21 | no | 70 | behenic acid | 96 | 15.6 |
| 870 | V-22 | yes | 120 | behenic acid | 113 | 3.2 |
| 871 | V-23 | yes | 210 | behenic acid | 113 | 3.2 |
| 872 | V-24 | no | 280 | behenic acid | 94 | 3.2 |
| 873 | V-25 | no | 70 | oleic acid | 94 | 16.1 |
| 874 | V-26 | yes | 120 | oleic acid | 111 | 3.3 |
| 875 | V-27 | yes | 210 | oleic acid | 111 | 3.3 |
| 876 | V-28 | no | 280 | oleic acid | 95 | 3.4 |
| 877 | V-29 | no | 70 | undecylenic acid | 96 | 16.2 |
| 878 | V-30 | yes | 150 | undecylenic acid | 110 | 3.4 |
| 879 | V-31 | yes | 250 | undecylenic acid | 110 | 3.3 |
| 880 | V-32 | no | 280 | undecylenic acid | 96 | 3.3 |

### Example 881: Production of Pigment Preparation W-1 (not in Accordance with the Invention)

An aqueous suspension of pigment W, as obtained after step b) of Example 23, was admixed with 70 g of Pristerene® 4910 and stirred for 60 minutes. Aqueous potassium hydroxide solution was subsequently used to establish a pH of 5. The pigment preparation was then isolated on a suction filter, washed, dried at 80° C. in a vacuum drying oven and ground in a customary laboratory mill for around 2 minutes. (=pigment preparation W-1)

### Examples 882 to 913: Production of Pigment Preparations W-2 to W-32 (not in Accordance with the Invention and According to the Invention)

Analogously to Example 881, pigment preparations W-2 to W-32, according to the invention and not in accordance with the invention, were produced in Examples 882 to 913. In each case, an aqueous suspension of the pigment W, as obtained after step b) of Example 23, was admixed with different aliphatic carboxylic acids B) or mixtures thereof in different amounts, as indicated in Table 25.

### Determination of Colour Strength and Filter Pressure Value

For pigment preparations W-1 to W-32, the colour strength compared to pigment W and the filter pressure value were determined according to protocols 1 and 2 indicated below. The values can also be found in Table 25.

TABLE 25
Pigment preparations with pigment W

| | | | Grams of aliphatic | | | |
|---|---|---|---|---|---|---|
| | | | carboxylic acid B) | Aliphatic | | |
| | | According | or mixture | carboxylic | Colour | |
| | Pigment | to the | per mole of | acid B) | strength | FPV |
| Example | preparation | invention | pigment | or mixture | [%] | [bar/g] |
| 881 | W-1 | no | 70 | Pristerene ® 4910 | 96 | 15.6 |
| 882 | W-2 | yes | 180 | Pristerene ® 4910 | 119 | 2.9 |
| 883 | W-3 | yes | 250 | Pristerene ® 4910 | 118 | 2.9 |
| 884 | W-4 | no | 280 | Pristerene ® 4910 | 96 | 3.0 |
| 885 | W-5 | no | 70 | caprylic acid | 95 | 16.2 |
| 886 | W-6 | no | 210 | caprylic acid | 94 | 16.3 |
| 887 | W-7 | no | 70 | nervonic acid | 94 | 15.9 |
| 888 | W-8 | no | 250 | nervonic acid | 92 | 15.8 |
| 890 | W-9 | no | 70 | myristic acid | 93 | 15.8 |
| 891 | W-10 | yes | 120 | myristic acid | 115 | 3.2 |
| 892 | W-11 | yes | 180 | myristic acid | 114 | 3.2 |
| 893 | W-12 | no | 280 | myristic acid | 96 | 3.3 |
| 894 | W-13 | no | 70 | palmitic acid | 96 | 15.4 |
| 895 | W-14 | yes | 150 | palmitic acid | 118 | 3.0 |
| 896 | W-15 | yes | 210 | palmitic acid | 117 | 3.0 |
| 897 | W-16 | no | 280 | palmitic acid | 95 | 3.1 |
| 898 | W-17 | no | 70 | stearic acid | 95 | 15.6 |
| 899 | W-18 | yes | 150 | stearic acid | 118 | 3.1 |
| 900 | W-19 | yes | 250 | stearic acid | 118 | 3.1 |
| 901 | W-20 | no | 280 | stearic acid | 96 | 3.1 |
| 902 | W-21 | no | 70 | behenic acid | 95 | 15.9 |
| 903 | W-22 | yes | 120 | behenic acid | 115 | 3.3 |
| 904 | W-23 | yes | 210 | behenic acid | 114 | 3.4 |
| 905 | W-24 | no | 280 | behenic acid | 95 | 3.4 |
| 906 | W-25 | no | 70 | oleic acid | 94 | 16.3 |
| 907 | W-26 | yes | 120 | oleic acid | 113 | 3.4 |
| 908 | W-27 | yes | 210 | oleic acid | 112 | 3.4 |
| 909 | W-28 | no | 280 | oleic acid | 94 | 3.4 |
| 910 | W-29 | no | 70 | undecylenic acid | 94 | 15.8 |
| 911 | W-30 | yes | 150 | undecylenic acid | 112 | 3.3 |
| 912 | W-31 | yes | 250 | undecylenic acid | 112 | 3.4 |
| 913 | W-32 | no | 280 | undecylenic acid | 96 | 3.4 |

TABLE 26
Reactants

| | C₁₀₋₂₂ carboxylic acid mixture | | | |
|---|---|---|---|---|
| | Typical composition in % by weight | | | |
| Commercial product of the | | | | Melting |
| company Unichema | C14 | C16 | C18 | range ° C. |
| Pristerene ® 4910 | 2 | 30 | 64 | 57.5-60 |
| Pristerene ® 4911 | 2 | 45 | 52 | 55-56 |
| Pristerene ® 9429 | | | | 52-60 |
| Pristerene ® 4922 | 0.7 | 30 | 66 | 51-55 |

| | | Chain | |
|---|---|---|---|
| | | length | |
| C₁₀₋₂₂ carboxylic acid | CAS No. | Cₙ= | Supplier |
| caprylic acid | 124-07-2 | 8 | Sigma-Aldrich |
| (octanoic acid, C₈H₁₆O₂) | | | |
| capric acid | 334-48-5 | 10 | Sigma-Aldrich |
| (n-decanoic acid, C₁₀H₂₀O₂) | | | |
| lauric acid | 143-07-7 | 12 | Sigma-Aldrich |
| (dodecanoic acid, C₁₂H₂₄O₂) | | | |
| myristic acid | 544-63-8 | 14 | Sigma-Aldrich |
| (tetradecanoic acid, C₁₄H₂₈O₂) | | | |
| palmitic acid | 57-10-3 | 16 | Sigma-Aldrich |
| (hexadecanoic acid, C₁₆H₃₂O₂) | | | |
| stearic acid | 57-11-4 | 18 | Sigma-Aldrich |
| (octadecanoic acid, C₁₈H₃₆O₂) | | | |
| behenic acid | 112-85-6 | 22 | Sigma-Aldrich |
| (n-docosanoic acid, C₂₂H₄₄O₂) | | | |
| lignoceric acid | 557-59-5 | 24 | Sigma-Aldrich |
| (tetracosanoic acid, C₂₄H₄₈O₂) | | | |
| oleic acid | 112-80-1 | 18 | Alfa |
| ((9Z)-octadec-9-enoic acid, | | | |
| C₁₈H₃₄O₂) | | | |
| undecylenic acid | 112-38-9 | 11 | Alfa |
| (undec-10-enoic acid, C₁₁H₂₀O₂) | | | |
| nervonic acid | 506-37-6 | 24 | Sigma-Aldrich |
| ((Z)-15-tetracosenoic acid, | | | |
| C₂₄H₄₆O₂) | | | |

The pigments produced according to Examples 1 to 22 and the pigment preparations produced according to Examples 23 to 913 were each subjected to a determination of the colour strength according to DIN 55986 (see protocol 1) and the filter pressure value according to DIN EN ISO 23900-5:2019-01 (see protocol 2).

### Determination of Colour Strength in PVC: Protocol 1

A plasticized PVC compound was produced as test medium by homogenization of 67.5% Vestolit® E7004 (Vestolit GmbH), 29.0% Hexamoll® DINCH (BASF), 2.25% Baerostab UBZ 770 (Baerlocher GmbH) and 1.25% Isocolor white pigment paste (ISL-Chemie) with a laboratory dissolver.

On a laboratory roll mill, 100 g of the PVC compound were applied at 150° C. to two 150 mm diameter rolls rotating at 20 min 1 and 18 min 1. Together with 0.10 g of pigment, a rolled sheet was produced by rotation, and was then guided eight times through a roll nip of 0.10 mm. The uniformly coloured rolled sheet was then removed after passing through a 0.8 mm roll nip and laid down smoothly on a metal surface. The cooled rolled sheet was then applied eight times through a roll nip of 0.2 mm to two unheated 110 mm diameter rolls rotating at 26 min 1 and 24 min 1. To smooth the surface, the resulting rolled sheet was applied to the rolls at 150° C. again, removed at 0.8 mm and laid out on a smooth surface for cooling. Specimens of this rolled sheet were used to determine the relative colour strength.

The relative colour strength was calculated after remission measurement of the specimens against a white background using a spectrophotometer with measurement geometry d/8 under standard illuminant D65 and 10° observer according to DIN 55986 using the sum of the K/S values over the visible spectrum in the range of 400 nm-700 nm.

Determination of the Filter Pressure Value (FPV) with the Pressure Filter Test According to DIN EN ISO 23900-5:2019-01 (Determination of the Pressure Increase): Protocol 2

1950 g of polyamide 6 (Durethan® B30S from LANXESS Deutschland GmbH, Cologne) with an addition of 1% titanium dioxide were mixed intensively with 50 g of the pigment to be tested for one hour on a tumble mixer. This mixture was extruded on a Leistritz ZSE 18HP twin-screw extruder at 225° C. and a speed of 700 rpm. 200 g of the granulated material produced in this way was filtered via a 25 μm filter at a temperature of 238° C. and the resulting pressure increase was measured. The pressure difference between the initial pressure and the maximum pressure was used to calculate the filter pressure value FPV. The lower this pressure increase, measured in bar/g, the better the filtration properties of the pigment preparation to be examined.

Conclusion: From the measurement results as set out in Tables 1 to 25, it can be seen that only the pigment preparations according to the invention have both an improved filtration property and an improved colour strength compared to the pigment preparations not in accordance with the invention.

1. A pigment preparation composed of
i) a metal azo pigment A) containing
a) at least two metal azo compounds of formula (I) which differ at least in the metal ion Me, or their tautomeric forms, 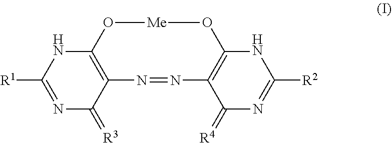
wherein
R¹ and R² are each independently OH, NH₂ or NHR⁵,
R³ and R⁴ are each independently O or NR⁵,
R⁵ is hydrogen or alkyl, and
Me is metal ions comprising a metal ion Me¹ in the first metal azo compound and a metal ion Me² in the second metal azo compound,
wherein
Me¹ is Zn²⁺ and Ni²⁺ and the molar ratio of Zn to Ni metal ions is 97:3 to 3:97, and
Me² is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺, Y³⁺_{2/3}, Sc³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba²⁺,
with the proviso that the amount of metal ions Me¹ is in total 97 to 100 mol % and the amount of metal ions selected from the Me² series is in total 0 to 3 mol %, based in each case on one mole of all compounds of formula (I), and
b) at least one compound of formula (II) 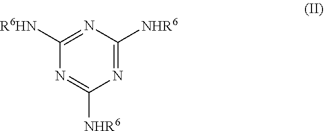
wherein
R⁶ is in each case independently hydrogen or alkyl, which is optionally substituted one or more times by OH,
or a reaction product of (I) with (II),
and
(ii) 100 to 250 g of at least one aliphatic C₁₀₋₂₂ monocarboxylic acid B) per mole of all metal azo compounds (I) contained in the metal azo pigment A).

2. A pigment preparation according to claim 1, wherein in the metal azo pigment A), the ratio of the at least two metal azo compounds of formula (I) to the at least one compound of formula (II) is 1 mol:0.05 to 4 mol.

3. A pigment preparation according to claim 1, wherein in the metal azo pigment A), the ratio of the at least two metal azo compounds of formula (I) to the at least one compound of formula (II) is 1 mol:0.5 to 2.5 mol.

4. A pigment preparation according to claim 1, wherein in the metal azo pigment A), the ratio of the at least two metal azo compounds of formula (I) to the at least one compound of formula (II) is 1 mol:1.0 to 2.0 mol.

5. A pigment preparation according to claim 1, wherein in formula (I) R¹ and R² are OH, R³ and R⁴ are O, the molar ratio of Zn to Ni metal ions is 90:10 to 30:70, Me² is Al³⁺_{2/3}, Fe²⁺, Fe³⁺_{2/3}, Co²⁺, Co³⁺_{2/3}, Ce³⁺_{2/3}, Mg²⁺, Ca²⁺, Sr²⁺, La³⁺_{2/3}, Mg²⁺, Mn²⁺, Nd²⁺, Nd³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺, Ca²⁺ or Ba²⁺, and b) is melamine or is a reaction product of formula (I) with melamine.

6. A pigment preparation according to claim 1, wherein the at least one aliphatic C₁₀₋₂₂ monocarboxylic acid B) is selected from saturated or mono- to triunsaturated carboxylic acids.

7. A pigment preparation according to claim 1, wherein the at least one aliphatic C₁₀₋₂₂ monocarboxylic acid B) is selected from capric acid, undecylenic acid, lauric acid, myristic acid, palmitic acid, stearic acid, oleic acid, and behenic acid.

8. A pigment preparation according to claim 7, wherein the at least one aliphatic C₁₀₋₂₂ monocarboxylic acid B) is present in pure form or as mixtures.

9. A pigment preparation according to claim 8, wherein the mixtures contain myristic acid, palmitic acid or stearic acid.

10. A method of improving the filter pressure value FPV to be determined by the pressure filter test according to DIN EN ISO 23900-5:2019-01 and the colour strength to be determined according to DIN 55986 of a pigment preparation, comprising the step of adding at least one aliphatic C₁₀₋₂₂ monocarboxylic acid B) to a metal azo pigment A), wherein the metal azo pigment A) is composed of
a) at least two metal azo compounds of formula (I) which differ at least in the metal ion Me, or their tautomeric forms, 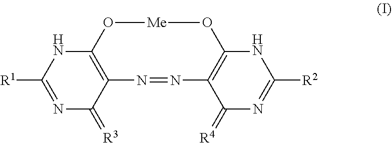
wherein
R¹ and R² are each independently OH, NH₂ or NHR⁵,
R³ and R⁴ are each independently O or NR⁵,
R⁵ is hydrogen or alkyl, and
Me is metal ions comprising a metal ion Me¹ in the first metal azo compound and a metal ion Me² in the second metal azo compound,
wherein
Me¹ is Zn²⁺ and Ni²⁺ and the molar ratio of Zn to Ni metal ions is 97:3 to 3:97, and
Me² is Al³⁺_{2/3}, Fe²⁺, Fe³⁺_{2/3}, Co²⁺, Co³⁺_{2/3}, La³⁺_{2/3}, Ce³⁺_{2/3}, Pr³⁺_{2/3-}, Nd²⁺, Nd³⁺_{2/3}, Sm²⁺, Sm³⁺_{2/3}, Eu²⁺, Eu³⁺_{2/3}, Gd³⁺_{2/3}, Tb³⁺_{2/3}, Dy³⁺_{2/3}, Ho³⁺_{2/3}, Yb²⁺, Yb³⁺_{2/3}, Er³⁺_{2/3}, Tm³⁺_{2/3}, Mg²⁺, Ca²⁺, Sr²⁺, Mn²⁺, Y³⁺_{2/3}, Sc³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺ or Ba^{2+,}
with the proviso that the amount of metal ions Me¹ is in total 97 to 100 mol % and the amount of metal ions selected from the Me² series is in total 0 to 3 mol %, based in each case on one mole of all compounds of formula (I), and
b) at least one compound of formula (II) 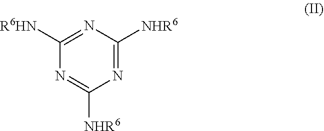
wherein
R⁶ is in each case independently hydrogen or alkyl, which is optionally substituted one or more times by OH,
or alternatively a reaction product of (I) with (II),
wherein 100 to 250 g of the aliphatic C₁₀₋₂₂ monocarboxylic acid B) are used per mole of the at least two metal azo compounds of formula (I) contained in the metal azo pigment A).

11. The method according to claim 10, wherein in the metal azo pigment A), the ratio of the at least two metal azo compounds of formula (I) to the at least one compound of formula (II) is 1 mol:0.05 to 4 mol.

12. The method according to claim 10, wherein in the metal azo pigment A), the ratio of the at least two metal azo compounds of formula (I) to the at least one compound of formula (II) is 1 mol:0.5 to 2.5 mol.

13. The method according to claim 10, wherein in the metal azo pigment A), the ratio of the at least two metal azo compounds of formula (I) to the at least one compound of formula (II) is 1 mol:1.0 to 2.0 mol.

14. The method according to claim 10, wherein in formula (I), R¹ and R² are OH, R³ and R⁴ are O, the molar ratio of Zn to Ni metal ions is 90:10 to 30:70, Me² is Al³⁺_{2/3}, Fe²⁺, Fe³⁺_{2/3}, Co²⁺, Co³⁺_{2/3}, Ce³⁺_{2/3}, Mg²⁺, Ca²⁺, Sr²⁺, La³⁺_{2/3}, Mg²⁺, Mn²⁺, Nd²⁺, Nd³⁺_{2/3}, Ti²⁺, Ti³⁺_{2/3}, Nb³⁺_{2/3}, Mo²⁺, Mo³⁺_{2/3}, V²⁺, V³⁺_{2/3}, Zr²⁺, Zr³⁺_{2/3}, Cd²⁺, Cr³⁺_{2/3}, Pb²⁺, Ca²⁺ or Ba²⁺, and b) is melamine or is a reaction product of formula (I) with melamine.

15. The method according to claim 10, wherein the at least one aliphatic C₁₀₋₂₂ monocarboxylic acid B) is selected from saturated or mono- to triunsaturated carboxylic acids.

16. The method according to claim 10, wherein the at least one C₁₀₋₂₂ monocarboxylic acid is selected from capric acid, undecylenic acid, lauric acid, myristic acid, palmitic acid, stearic acid, oleic acid and behenic acid.

17. The method according to claim 16, wherein the at least one aliphatic C₁₀₋₂₂ monocarboxylic acid B) is present in pure form or as mixtures.

18. The method according to claim 17, wherein the mixtures contain myristic acid, palmitic acid or stearic acid.

19.-26. (canceled)

27. The pigment preparation according to claim 1, wherein R⁵ and/or R⁶ is C₁-C₄ alkyl.

28. The method according to claim 10, wherein R⁵ and/or R⁶ is C₁-C₄ alkyl.
